(19) United States
(12) Patent Application Publication
(10) Pub. No.: US 2019/0139070 A1
(43) Pub. Date: May 9, 2019

(54) SYSTEMS AND METHODS FOR CHEAT EXAMINATION

(71) Applicant: BEIJING DIDI INFINITY TECHNOLOGY AND DEVELOPMENT CO., LTD., Beijing (CN)

(72) Inventors: Tianming ZHANG, Beijing (CN); Rui GUO, Beijing (CN)

(73) Assignee: BEIJING DIDI INFINITY TECHNOLOGY AND DEVELOPMENT CO., LTD., Beijing (CN)

(21) Appl. No.: 16/236,617

(22) Filed: Dec. 30, 2018

Related U.S. Application Data
(63) Continuation of application No. PCT/CN2018/087995, filed on May 23, 2018.

(30) Foreign Application Priority Data
Jun. 28, 2017 (CN) 201710512144.9
Nov. 1, 2017 (CN) 201711058496.8

(51) Int. Cl. G06Q 30/02; G06N 7/00

(52) U.S. Cl. CPC G06Q 30/0225; G06N 7/005

(57) ABSTRACT

A system includes a storage device storing a set of instructions and a processor in communication with the storage device. When executing the set of instructions, the processor is configured to cause the system to receive, via a network, a service order from a terminal and obtain reference information relating to the service order. The processor also causes the system to determine actual information of the service order. The processor further causes the system to determine, based on the reference information and the actual information, whether the service order is a cheating service order.

### CROSS-REFERENCE TO RELATED APPLICATIONS

This application is a Continuation of International Application No. PCT/CN2018/087995, filed on May 23, 2018, which claims priority to Chinese Application No. 201710512144.9 filed on Jun. 28, 2017, and Chinese Application No. 201711058496.8 filed on Nov. 1, 2017. Each of the above-referenced applications is incorporated herein by reference in its entirety.

### TECHNICAL FIELD

The present disclosure generally relates to systems and methods for online-to-offline service, and in particular, to systems and methods for identifying cheating service orders.

### BACKGROUND

An online car-hailing platforms may provide various coupons, subsidies, and rewards to service providers and requesters who have finished a certain number of service orders to encourage more usage of the platform and to cultivate habits of using the platform. These incentives, however, at the same time encourage some users to try to game the system by engaging more cheating or sham service orders in order to receive the rewards that they are not qualified. For example, a driver and a passenger may collude to complete a sham service. The passenger sends a service order in advance, and the driver accepts the service order. The driver drives a short distance and ends the service. By repeating this kind of sham services, the driver may accumulate a certain amount of service orders to meet conditions of receiving rewards. This behavior may cause great losses to the platform. It may be desirable to develop systems and methods to identify cheating orders effectively.

### SUMMARY

According to an aspect of the present disclosure, a system is provided. The system may include an acquisition module, a calculation module, a first judgment module, and a second judgment module. The acquisition module may be configured to collect, via a network, checkpoint information relating to each checkpoint of a plurality of checkpoints. In some embodiments, the plurality of checkpoints may be associated with a service order. The calculation module may be configured to generate a plurality of data groups based on the checkpoint information. For each data group of the plurality of data groups, the first judgment module may be configured to determine whether data relating to the each data group of the plurality of data groups is within a predetermined range and determine whether the each data group has reachability based on a result of the determination whether the data relating to the each data group of the plurality of data groups is within the predetermined range. The second judgment module may be configured to determine whether the service order is a cheating service order based on a result of the determination of the reachability of the plurality of data groups.

In some embodiments, the checkpoint information relating to each checkpoint may include an event name, a time point, and a position coordinate. In some embodiments, each data group includes a time difference value, a distance value, and a speed value.

In some embodiments, the calculation module may include a grouping unit, a first calculation unit, a second calculation unit, and a third calculation unit. The grouping unit may be configured to arrange the plurality of checkpoints in chronological order and designate two adjacent checkpoints in the chronological order as a data group. For each data group of the plurality of data groups, the first calculation unit may be configured to determine a straight distance value between two position coordinates relating to the each data group and designate the determined straight distance value as the distance value of the each data group, the second calculation unit may be configured to determine a difference between two time points relating to the each data group and designate the determined difference as the time difference value of the each data group, the third calculation unit may be configured to determine a quotient based on the time difference value and the distance value of the each data group and designate the determined quotient as a speed value of the each data group.

In some embodiments, the first judgment module may include a first judgment unit, an assessment unit, a second judgment unit, and a third judgment unit. For each data group of the plurality of data groups, the first judgment unit may be configured to determine whether the time difference value of the each data group is larger than a predetermined time difference threshold. If the time difference value of the each data group is larger than the predetermined time difference threshold, the assessment unit may be configured to determine for a statistical maximum speed value corresponding to the each data group and determine a speed threshold relating to the each data group. In some embodiments, the statistical maximum speed value may be determined based on the actual road condition of the day of the service order. The second judgment unit may be configured to determine whether the speed value of the each data group is less than or equal to the speed threshold. If the speed value of the each data group is less than or equal to the speed threshold, the second judgment unit may be further configured to determine that the each data group has reachability. If the time difference value of the each data group is less than or equal to the predetermined time difference threshold, the third judgment unit may be configured to determine whether the distance value of the each data group is less than or equal to a predetermined distance threshold. If the distance value of the each data group is less than or equal to the predetermined distance threshold, the third judgment unit may be further configured to determine that the each data group has reachability.

In some embodiments, the assessment unit may include a first determination unit, an inquiry unit, a fourth judgment unit, a second determination unit, and a third determination unit. The first determination unit may be configured to determine a time period to which two time points relating to information of two corresponding checkpoints belong and a geographic region where two position coordinates relating to the information of the two corresponding checkpoints lie, respectively. The inquiry unit may be configured to determine for one or more statistical maximal speed values in both the time period and the geographic region. The fourth judgment unit may be configured to determine whether a difference of speed value between two statistical maximal speed values corresponding to the two time points is less than or equal to a predetermined difference value. If the difference of speed value is less than or equal to the predetermined difference value, the second determination unit may be configured to designate an average value of the two statistical maximal speed values as the statistical maximum speed value. If the difference of speed value is larger than the predetermined difference value, the third determination unit may be configured to designate a larger one of the two statistical maximal speed values as the statistical maximum speed value. The fourth determination unit may be configured to determine the speed threshold by multiplying the statistical maximum speed value by a predetermined ratio.

In some embodiments, the second judgment module may include a fourth calculation unit and a fourth judgment unit. The fourth calculation unit may be configured to determine a proportion of the plurality of data groups that have reachability as a ratio of reachability of the service order. The fourth judgment unit may be configured to determine whether the ratio of reachability is less than or equal to a predetermined probability. If the ratio of reachability is less than or equal to the predetermined probability, the fourth judgment unit may be further configured to determine that the service order is a cheating service order.

In some embodiments, the acquisition module executes a step of collecting the checkpoint information from a passenger terminal and a driver terminal.

In some embodiments, the system may further include a third judgment module. The third judgment module may be configured to determine whether reachability relating to all the plurality of data groups has been determined. If the reachability relating to each data group of the plurality of data groups has been determined, the third judgment module may be further configured to activate the second judgment module. If the reachability relating to all the plurality of data groups has not been determined, the third judgment module may be further configured to activate the first judgment module.

In some embodiments, a number count of the plurality of checkpoints is at least three.

According to another aspect of the present disclosure, a system may include a storage device storing a set of instructions and one or more processors in communication with the storage device. When executing the instructions, one or more processors may be configured to cause the system to collect, via a network, checkpoint information relating to each checkpoint of a plurality of checkpoints and generate a plurality of data groups based on the checkpoint information. In some embodiments, the plurality of checkpoints may be associated with a service order. For each data group of the plurality of data groups, the one or more processors may also cause the system to determine whether data relating to the each data group of the plurality of data groups is within a predetermined range and determine whether the each data group has reachability based on a result of the determination whether the data relating to the each data group of the plurality of data groups is within the predetermined range. The one or more processors may further cause the system to determine whether the service order is a cheating service order based on a result of the determination of the reachability of the plurality of data groups.

According to still another aspect of the present disclosure, a computer-implemented method may include one or more of the following operations performed by one or more processors. The method may include collecting, via a network, checkpoint information relating to each checkpoint of a plurality of checkpoints. In some embodiments, the plurality of checkpoints may be associated with a service order and generating a plurality of data groups based on the checkpoint information. For each data group of the plurality of data groups, the method may also include determining whether data relating to the each data group of the plurality of data groups is within a predetermined range and determining whether the each data group has reachability based on a result of the determination whether the data relating to the each data group of the plurality of data groups is within the predetermined range. The method may further include determining whether the service order is a cheating service order based on a result of the determination of the reachability of the plurality of data groups.

According to still another aspect of the present disclosure, a terminal device including the system for examining a cheating service order is provided.

According to still another aspect of the present disclosure, a computing device including a storage device, a processor, and a computer program may be provided. In some embodiments, the computer program may be stored in the storage device and executed by the processor. When executing the computer program, the processor may be directed to effectuate steps of any method of examining a cheating service order described above.

According to still another aspect of the present disclosure, a recognition device of a cheating service order in a scenario of online car-hailing is provided. The recognition device may include a path generation unit, a reference information determination unit, an actual information determination unit, and a cheat judgment unit. The path generation unit may be configured to generate a recommended driving path based on a start location and a destination of a service order. The reference information determination unit may be configured to determine reference driving information based on the recommended driving path. The actual information determination unit may be configured to determine actual driving information of the service order. The cheat judgment unit may be configured to determine, based on the reference driving information and the actual driving information, whether the service order is a cheating service order.

In some embodiments, the reference driving information may include a reference time period during which an acceleration equals a first predetermined value. In some embodiments, the actual driving information may include an actual time period during which an acceleration equals the first predetermined value. The cheat judgment unit may be further configured to determine that an absolute value of a time difference between the reference time period and the actual time period is larger than a predetermined time difference threshold and determine that the service order is a cheating service order based on a result of the determination that the absolute value of the time difference is larger than the predetermined time difference threshold.

In some embodiments, the reference information determination unit may be further configured to determine, based on a congestion condition relating to the recommended driving path, a first reference time period during which the acceleration equals the first predetermined value. The reference information determination unit may be further configured to determine, based on intersection information relating to the recommended driving path, a second reference time period during which the acceleration equals the first predetermined value. The reference information determination unit may be further configured to designate the sum of the first reference time period and the second reference time period as the reference time period.

In some embodiments, the actual information determination unit may be further configured to determine the actual time period during which the acceleration equals the first predetermined value based on information relating to the acceleration uploaded by a driver terminal, wherein the information relating to the acceleration is obtained from a sensor of the driver terminal.

In some embodiments, the first predetermined value may be zero.

In some embodiments, the reference driving information may include reference driving trails. Each of the reference driving trails may correspond to one of one or more segments of the recommended driving path. In some embodiments, the actual driving information may include coordinate points uploaded by a driver terminal during a process for completing the service order. In some embodiments, for each of one or more segments of the recommended driving path, the cheat judgment unit may be further configured to determine a deviation between coordinate points belonging to the each of the one or more segments and a reference driving trail corresponding to the each of the one or more segments and determine, based on the deviations, an average deviation of the one or more segments. The cheat judgment unit may be further configured to determine whether the average deviation is less than a deviation threshold and determine that the service order is a cheating service order based on a determination result that the average deviation is less than the deviation threshold.

In some embodiments, the reference information determination unit may be further configured to divide the recommended driving path into one or more segments and, for each of the one or more segments, determine a reference fitting function relating to the each of the one or more segments. The reference information determination unit may be further configured to designate the reference fitting function as the reference driving trail corresponding to the each of the one or more segments.

In some embodiments, the actual information determination unit may be further configured to, for each of coordinate points belonging to the each of the one or more segments, determine a distance between the each of coordinate points and the reference driving trail corresponding to the each of the one or more segments. The actual information determination unit may be further configured to determine an average distance of the distances between the coordinate points and the reference driving trail corresponding to the each of the one or more segments and designate the average distance as the deviation between the coordinate points belonging to the each of the one or more segments and the reference driving trail corresponding to the each of the one or more segments.

In some embodiments, the cheat judgment unit may be further configured to determine, based on the actual driving information, a number count of segments of an actual driving path and determine whether the number count is equal to or larger than a predetermined number. The cheat judgment unit may be further configured to execute, based on the reference driving information and the actual driving information, a step of determining whether the service order is a cheating service order based on a determination result that number is equal to or larger than the predetermined number.

According to another aspect of the present disclosure, a system may include a storage device storing a set of instructions and one or more processors in communication with the storage device. When executing the instructions, one or more processors may be configured to cause the system to generate a recommended driving path based on a start location and a destination of a service order and determine reference driving information based on the recommended driving path. The one or more processors may also cause the system to determine actual driving information of the service order and determine, based on the reference driving information and the actual driving information, whether the service order is a cheating service order.

According to still another aspect of the present disclosure, a computer-implemented method may include one or more of the following operations performed by one or more processors. The method may include generating a recommended driving path based on a start location and a destination of a service order and determining reference driving information based on the recommended driving path. the method may also include determining actual driving information of the service order and determining, based on the reference driving information and the actual driving information, whether the service order is a cheating service order.

According to still another aspect of the present disclosure, a recognition device of a cheating service order in a scenario of online car-hailing is provided. The device may include a processor, a storage device storing machine-executable instructions. The machine-executable instructions may correspond to recognition logic of a cheating service order in the scenario of online car-hailing. When reading and executing the machine-executable instructions stored in the storage device, the processor may be directed to generate a recommended driving path based on a start location and a destination of a service order and determine reference driving information based on the recommended driving path. The processor may be further directed to determine actual driving information of the service order and determine, based on the reference driving information and the actual driving information, whether the service order is a cheating service order.

According to still another aspect of the present disclosure, a computer-readable medium storing a computer program is provided. When executed by a processor, the computer program may be directed to effectuate following steps. The following steps may include generating a recommended driving path based on a start location and a destination of a service order and determining reference driving information based on the recommended driving path. The following steps may also include determining actual driving information of the service order and determining, based on the reference driving information and the actual driving information, whether the service order is a cheating service order.

According to still another aspect of the present disclosure, a system is provided. The system may include a storage device storing a set of instructions and one or more processors in communication with the storage device. When executing the set of instructions, the one or more processors may be configured to cause the system to receive, via a network, a service order from a terminal and obtain reference information relating to the service order. The one or more processors may be further configured to cause the system to determine actual information of the service order and determine, based on the reference information and the actual information, whether the service order is a cheating service order.

In some embodiments, the reference information includes a first predetermined time difference threshold, a predetermined distance threshold, a speed threshold, and a predetermined probability.

In some embodiments, the one or more processors may be further configured to cause the system to receive, via the network, checkpoint information relating to a plurality of checkpoints, the plurality of checkpoints being associated with the service order and arrange, based on the time points associated with the plurality of checkpoints, the plurality of checkpoints in chronological order. In some embodiments, each of the plurality of checkpoints may be associated with a time point and a position. The one or more processors may be further configured to cause the system to determine a plurality of data groups relating to the service order based on the plurality of checkpoints and, for each of the plurality of data groups, determine, based on time points and positions coordinates relating to the each of plurality of data groups, a time difference value, a distance value, and a speed value. In some embodiments, each of the plurality of data groups may include two adjacent checkpoints in the chronological order.

In some embodiments, for each of the plurality of data groups, the one or more processors may be configured to cause the system to determine whether the time difference value of the each of the plurality of data groups is larger than the first predetermined time difference threshold and determine, based on a result of the determination that the time difference value of the each of the plurality of data groups is larger than the first predetermined time difference threshold, whether the speed value of the each of the plurality of data groups is less than or equal to the speed threshold. The one or more processors may be further configured to cause the system to determine, based on a result of the determination that the speed value of the each of the plurality of data groups is less than or equal to the speed threshold, that the each of the plurality of data groups has reachability.

In some embodiments, for the each of the plurality of data groups, the one or more processors may be configured to cause the system to determine whether the time difference value of the each of the plurality of data groups is less than or equal to the first predetermined time difference threshold and determine, based on a result of the determination that the time difference value of the each of the plurality of data groups is less than or equal to the first predetermined time difference threshold, whether the distance value of the each of the plurality of data groups is less than or equal to the predetermined distance threshold. The one or more processors may be further configured to cause the system to determine, based on a result of the determination that the distance value of the each of the plurality of data groups is less than or equal to the predetermined distance threshold, that the each of the plurality of data groups has reachability.

In some embodiments, the one or more processors may be configured to cause the system to determine a proportion of the plurality of data groups that have reachability as a ratio of reachability of the service order and determine whether the ratio of reachability is less than or equal to the predetermined probability. The one or more processors may be configured to cause the system to determine, based on a result of the determination that the ratio of reachability is less than or equal to the predetermined probability, that the service order is a cheating service order.

In some embodiments, the reference information may include a recommended driving path and a reference time period. In some embodiments, the one or more processors may be configured to cause the system to generate the recommended driving path based on a start location and a destination of the service order and estimate, based on a congestion condition relating to the recommended driving path, a first reference time period during which an acceleration equals a first predetermined value. The one or more processors may be further configured to cause the system to estimate, based on intersection information relating to the recommended driving path, a second reference time period during which the acceleration equals the first predetermined value and determine a sum of the first reference time period and the second reference time period. The one or more processors may be further configured to cause the system to designate the sum as the reference time period.

In some embodiments, the actual information may include an actual time period during which an acceleration of a vehicle associated with the service order equals to the first predetermined value. In some embodiments, the one or more processors may be configured to cause the system to determine whether an absolute value of a time difference between the reference time period and the actual time period is larger than a second predetermined time difference threshold and determine, based on a result of the determination that the absolute value of the time difference is larger than the second predetermined time difference threshold, that the service order is a cheating service order.

In some embodiments, the reference information may include a recommended driving path, reference driving trails, and a deviation threshold. In some embodiments, the one or more processors may be configured to cause the system to generate the recommended driving path based on a start location and a destination of the service order and divide the recommended driving path into a plurality of segments. For each of the plurality of segments, the one or more processors may be further configured to cause the system to determine a reference fitting function relating to the each of the plurality of segments and designate the reference fitting function as the reference driving trail corresponding to the each of the plurality of segments.

In some embodiments, the actual information of the service order may include coordinate points belonging to the each of the plurality of segments and uploaded by a driver terminal in a process for completing the service order. In some embodiments, the one or more processors may be configured to cause the system to, for each of the plurality of segments of the recommended driving path, determine a deviation between the coordinate points belonging to the each of the plurality of segments and a reference driving trail corresponding to the each of the plurality of segments and determine, based on the deviations of the plurality of segments, an average deviation relating to the plurality of segments. The one or more processors may be further configured to cause the system to determine whether the average deviation is less than the deviation threshold and determine, based on a result of the determination that the average deviation is less than the deviation threshold, that the service order is a cheating service order.

In some embodiments, the reference information may include a predetermined number. In some embodiments, the one or more processors may be configured to cause the system to determine, based on the actual information, a number count of segments of an actual driving path relating to the service order and determine whether the number count is equal to or larger than the predetermined number. The one or more processors may be configured to cause the system to determine, based on a result of the determination that the number count is equal to or larger than the predetermined number, that the service order is not a cheating service order.

According to still another aspect of the present disclosure, a computer-implemented method may include one or more of the following operations performed by one or more processors. The method may include receiving, via a network, a service order from a terminal and obtaining reference information relating to the service order. The method may also include determining actual information of the service order and determining, based on the reference information and the actual information, whether the service order is a cheating service order.

According to still another aspect of the present disclosure, a non-transitory computer-readable medium storing instructions may be provided. When executed by one or more processors of a system, the instructions may cause the system to receive, via a network, a service order from a terminal and obtain reference information relating to the service order. The instructions may also cause the system to determine actual information of the service order and determine, based on the reference information and the actual information, whether the service order is a cheating service order.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary online-to-offline service system according to some embodiments;

FIG. 2 is a schematic diagram illustrating exemplary hardware and software components of a computing device according to some embodiments;

FIG. 3 is a schematic diagram illustrating exemplary hardware and/or software components of a mobile device according to some embodiments of the present disclosure;

FIG. 4 is a flowchart of an exemplary process for examining a cheating service order according to a first embodiment of the present disclosure.

FIG. 5 is a flowchart of an exemplary process for generating the data group in the embodiments described above in connection with FIG. 4.

FIG. 6 is a flowchart of an exemplary process for determining whether the data group has the reachability in the embodiments described above in connection with FIG. 4.

FIG. 7 is a flowchart of an exemplary process for determining the speed threshold in the embodiments described above in connection with FIG. 6.

FIG. 8 is a flowchart of an exemplary process for determining whether the service order is a cheating service order in the embodiments described above in connection with FIG. 4.

FIG. 9 is a flowchart of an exemplary process for examining a cheating service order according to some embodiments of the present disclosure;

FIG. 10A and FIG. 10B are a flowchart of an exemplary process examining a cheating service order according to some embodiments of the present disclosure.

FIG. 11 is a schematic block diagram of a system for examining a cheating service order according to a first embodiment of the present disclosure.

FIG. 12 is a schematic block diagram of a system for examining a cheating service order according to a second embodiment of the present disclosure.

FIG. 13 is a schematic block diagram of a system for examining a cheating service order according to a third embodiment of the present disclosure.

FIG. 14 is a schematic block diagram of a system for examining a cheating service order according to a fourth embodiment of the present disclosure.

FIG. 15 is a schematic block diagram of a system for examining a cheating service order according to a fifth embodiment of the present disclosure.

FIG. 16 is a schematic block diagram of a system for examining a cheating service order according to a sixth embodiment of the present disclosure.

FIG. 17 is a schematic block diagram of a terminal device according to some embodiments of the present disclosure.

FIG. 18 is a flowchart of an exemplary process for recognizing a cheating service order in a scenario of online car-hailing according to some embodiments of the present disclosure.

FIG. 19 is a flowchart of an exemplary process for recognizing a cheating service order in a scenario of online car-hailing according to an embodiment.

FIG. 20 is a flowchart of an exemplary process for recognizing a cheating service order in a scenario of online car-hailing according to some embodiments.

FIG. 21 is a schematic diagram of segmentation of a path according to some embodiments.

FIG. 22 is a schematic diagram of segmentation of a path according to some embodiments.

FIG. 23 is a schematic diagram of distances between position coordinates and a corresponding reference driving trail according to some embodiments.

FIG. 24 is a schematic diagram of a recognition device of a cheating service order in a scenario of online car-hailing according to some embodiments.

FIG. 25 is a block diagram illustrating an exemplary processing engine according to some embodiments of the present disclosure; and

FIG. 26 is a flowchart of an exemplary process for determining whether a service order is a cheating service order according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, steps, elements, and/or components, but do not preclude the presence or addition of one or more other features, integers, steps, steps, elements, components, and/or groups thereof.

These and other features, and characteristics of the present disclosure, as well as the methods of step and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate steps that systems implement according to some embodiments described in the present disclosure. It is to be expressly understood, the steps of the flowchart may be implemented not in order. Conversely, the steps may be implemented in inverted order, or simultaneously. Moreover, one or more other steps may be added to the flowcharts. One or more steps may be removed from the flowcharts.

Moreover, while the system and method in the present disclosure are described primarily with regard to distributing a request for a transportation service, it should also be understood that the present disclosure is not intended to be limiting. The system or method of the present disclosure may be applied to any other kind of online-to-offline service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for transmitting and/or receiving an express. The application of the system or method of the present disclosure may be implemented on a user device and include a web page, a plug-in of a browser, a client terminal, a custom system, an internal analysis system, an artificial intelligence robot, or the like, or any combination thereof.

The term “passenger,” “requestor,” “service requestor,” and “customer” in the present disclosure are used interchangeably to refer to an individual, an entity, or a tool that may request or order a service. Also, the term “driver,” “provider,” and “service provider” in the present disclosure are used interchangeably to refer to an individual, an entity, or a tool that may provide a service or facilitate the providing of the service.

The term “service request,” “request for a service,” “requests,” and “order” in the present disclosure are used interchangeably to refer to a request that may be initiated by a passenger, a service requestor, a customer, a driver, a provider, a service provider, or the like, or any combination thereof. The service request may be accepted by any one of a passenger, a service requestor, a customer, a driver, a provider, or a service provider. The service request may be chargeable or free.

The term “service provider terminal” and “driver terminal” in the present disclosure are used interchangeably to refer to a mobile terminal that is used by a service provider to provide a service or facilitate the providing of the service. The term “service requestor terminal” and “passenger terminal” in the present disclosure are used interchangeably to refer to a mobile terminal that is used by a service requestor to request or order a service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to online systems and methods for determining whether a service order is a cheating (or fake) service order. Reference information and actual information related to a service order may be obtained. Whether the service order is a cheating service order may be determined based on the reference and the actual information. In some embodiments, checkpoint information related to the service order may be obtained. Data groups may be determined based on the checkpoint information. The reachability in both time and space and relating to each data group may be determined. Whether the service order is a cheating service order may be determined based on a determination result of the reachability relating to each data group.

In another embodiment, reference time period during which an acceleration of a vehicle related to the service order equals to a first predetermined value may be determined. The actual time period during which the acceleration equals to a first predetermined value may be determined. Whether the service order is a cheating service order may be determined based on the reference time period and the actual time period. In some embodiments, reference driving trails relating to the service order may be determined. Position coordinates relating to the service order may be uploaded by a terminal during a process for completing the service order may be determined. Whether the service order is a cheating service order may be determined based on deviations between the reference driving trails and the position coordinates.

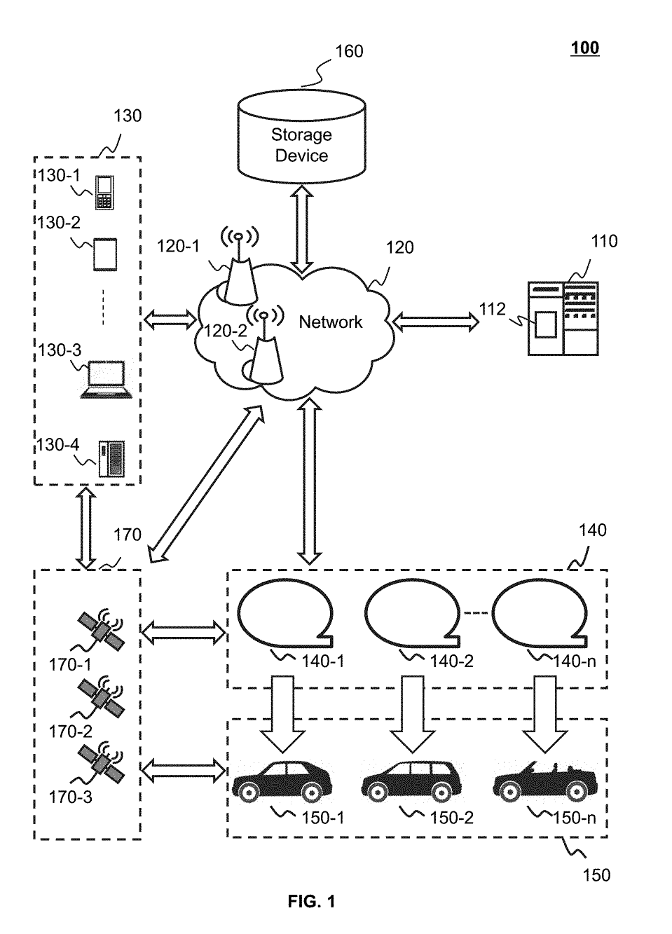

FIG. 1 is a block diagram illustrating an exemplary online-to-offline service system 100 according to some embodiments. For example, the online-to-offline service system 100 may be an online transportation service platform for transportation services. The online-to-offline service system 100 may include a server 110, a network 120, a service requestor terminal 130, a service provider terminal 140, a vehicle 150, a storage device 160, and a navigation system 170.

The online-to-offline service system 100 may provide a plurality of services. Exemplary service may include a taxi-hailing service, a chauffeur service, an express car service, a carpool service, a bus service, a driver hire service, and a shuttle service. In some embodiments, the online-to-offline service may be an online service, such as booking a meal, shopping, or the like, or any combination thereof.

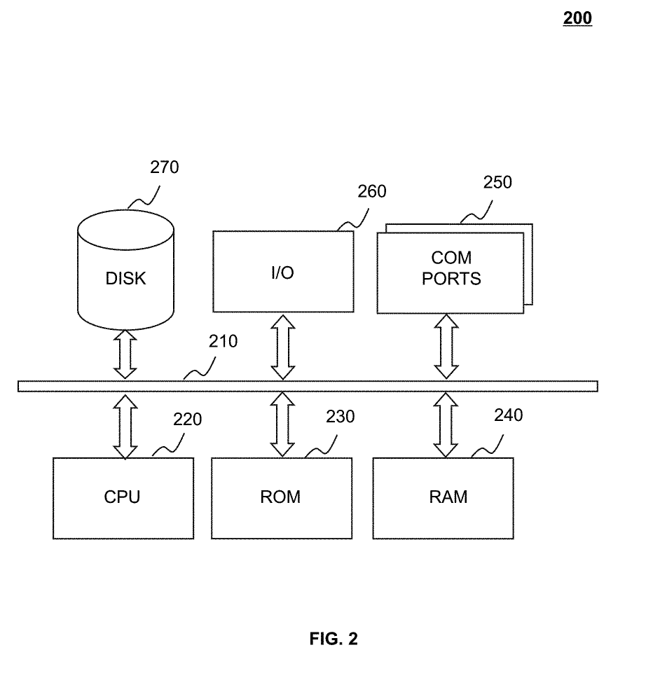

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the service requestor terminal 130, the service provider terminal 140, and/or the storage device 160 via the network 120. As another example, the server 110 may be directly connected to the service requestor terminal 130, the service provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may traverse spatial data. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the online-to-offline service system 100 (e.g., the server 110, the service requestor terminal 130, the service provider terminal 140, the vehicle 150, the storage device 160, and the navigation system 170) may send information and/or data to other component(s) in the online-to-offline service system 100 via the network 120. For example, the server 110 may receive a service request from the service requestor terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the online-to-offline service system 100 may be connected to the network 120 to exchange data and/or information.

In some embodiments, a passenger may be an owner of the service requestor terminal 130. In some embodiments, the owner of the service requestor terminal 130 may be someone other than the passenger. For example, an owner A of the service requestor terminal 130 may use the service requestor terminal 130 to send a service request for a passenger B or receive a service confirmation and/or information or instructions from the server 110. In some embodiments, a service provider may be a user of the service provider terminal 140. In some embodiments, the user of the service provider terminal 140 may be someone other than the service provider. For example, a user C of the service provider terminal 140 may use the service provider terminal 140 to receive a service request for a service provider D, and/or information or instructions from the server 110. In some embodiments, “passenger” and “passenger terminal” may be used interchangeably, and “service provider” and “service provider terminal” may be used interchangeably. In some embodiments, the service provider terminal may be associated with one or more service providers (e.g., a night-shift service provider, or a day-shift service provider).

In some embodiments, the service requestor terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the service requestor terminal 130 may be a device with positioning technology for locating the position of the passenger and/or the service requestor terminal 130.

The service provider terminal 140 may include a plurality of service provider terminals 140-1, 140-2, . . . , 140-n. In some embodiments, the service provider terminal 140 may be similar to, or the same device as the service requestor terminal 130. In some embodiments, the service provider terminal 140 may be customized to be able to implement the online-to-offline service. In some embodiments, the service provider terminal 140 may be a device with positioning technology for locating the service provider, the service provider terminal 140, and/or a vehicle 150 associated with the service provider terminal 140. In some embodiments, the service requestor terminal 130 and/or the service provider terminal 140 may communicate with another positioning device to determine the position of the passenger, the service requestor terminal 130, the service provider, and/or the service provider terminal 140. In some embodiments, the service requestor terminal 130 and/or the service provider terminal 140 may periodically send the positioning information to the server 110. In some embodiments, the service provider terminal 140 may also periodically send the availability status to the server 110. The availability status may indicate whether a vehicle 150 associated with the service provider terminal 140 is available to carry a passenger. For example, the service requestor terminal 130 and/or the service provider terminal 140 may send the positioning information and the availability status to the server 110 every thirty minutes. As another example, the service requestor terminal 130 and/or the service provider terminal 140 may send the positioning information and the availability status to the server 110 each time the user logs into the mobile application associated with the online-to-offline service.

In some embodiments, the service provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi hailing service, a chauffeur service, an express car service, a carpool service, a bus service, a driver hire service and a shuttle service).

The storage device 160 may store data and/or instructions. In some embodiments, the storage device 160 may store data obtained from the service requestor terminal 130 and/or the service provider terminal 140. In some embodiments, the storage device 160 may store data and/or instructions that the server 110 may execute or use to perform exemplary methods described in the present disclosure. In some embodiments, the storage device 160 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components in the online-to-offline service system 100 (e.g., the server 110, the service requestor terminal 130, the service provider terminal 140, etc.). One or more components in the online-to-offline service system 100 may access the data or instructions stored in the storage device 160 via the network 120. In some embodiments, the storage device 160 may be directly connected to or communicate with one or more components in the online-to-offline service system 100 (e.g., the server 110, the service requestor terminal 130, the service provider terminal 140, etc.). In some embodiments, the storage device 160 may be part of the server 110.

The navigation system 170 may determine information associated with an object, for example, one or more of the service requestor terminal 130, the service provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may send the information mentioned above to the network 120, the service requestor terminal 130, the service provider terminal 140, or the vehicle 150 via wireless connections.

In some embodiments, one or more components in the online-to-offline service system 100 (e.g., the server 110, the service requestor terminal 130, the service provider terminal 140, etc.) may have permissions to access the storage device 160. In some embodiments, one or more components in the online-to-offline service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

In some embodiments, information exchanging of one or more components in the online-to-offline service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in software of a mobile terminal, a program, a system, or the like, or any combination thereof. The mobile terminal may include a tablet computer, a laptop computer, a mobile phone, a personal digital assistant (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application related to transportation may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the service requestor terminal 130, and/or the service provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general-purpose computer or a special purpose computer; both may be used to implement an online to the offline service system for the present disclosure. The computing device 200 may be used to implement any component of the online-to-offline service as described herein. For example, the processing engine 112 may be implemented on the computing device 200, via its hardware, software program, firmware, or a combination thereof. Although only one such computer is shown, for convenience, the computer functions relating to the online-to-offline service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors, for executing program instructions. The exemplary computing device may include an internal communication bus 210, program storage and data storage of different forms including, for example, a disk 270, and a read-only memory (ROM) 230, or a random access memory (RAM) 240, for various data files to be processed and/or transmitted by the computing device. The exemplary computing device may also include program instructions stored in the ROM 230, RAM 240, and/or another type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

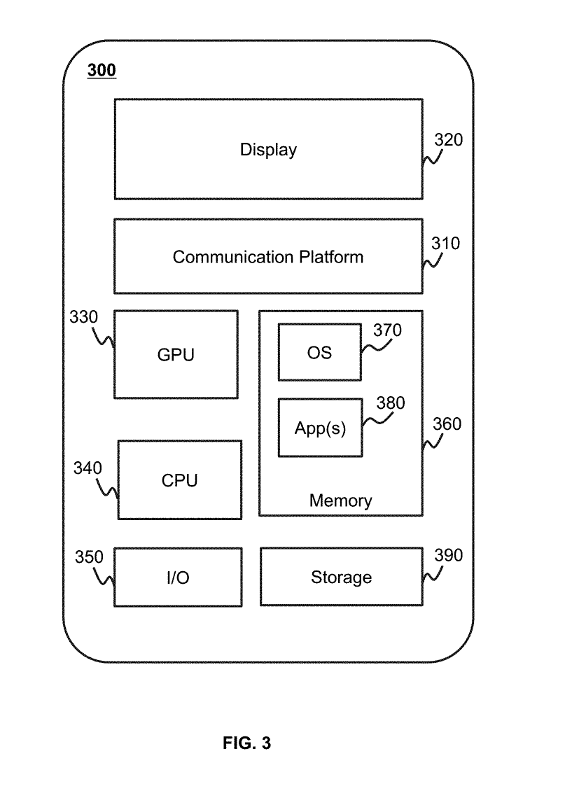

FIG. 3 is a schematic diagram illustrating exemplary hardware and/or software components of a mobile device 300 according to some embodiments of the present disclosure. As illustrated in FIG. 3, the mobile device 300 may include a communication module 310, a display 320, a graphics processing unit (GPU) 330, a processor 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the processor 340. The applications 380 may include a browser or any other suitable apps for transmitting, receiving and presenting information relating to the status of the vehicle 150 (e.g., the location of the vehicle 150) from the server 110. User interactions with the information stream may be achieved via the I/O 350 and provided to the server 110 and/or other components of the online-to-offline service system 100 via the network 120.

In some embodiments, one or more operations of processes of following methods may be implemented in the online-to-offline service system 100 illustrated in FIG. 1. For example, the processes of the following methods (e.g., the processes 400, the processes 500, the processes 600, the processes 700, the processes 800, the processes 900, the processes 1000, the processes 1800, the processes 1900, the processes 2000, the processes 2600) may be stored in the storage device 160 in the form of instructions, and invoked and/or executed by the processing engine 112 (e.g., the processor 220 of the computing device 200 as illustrated in FIG. 2, the processor 340 of the mobile device 300 as illustrated in FIG. 3). The processing engine 112 may perform the operations of the following methods. In another embodiment, at least a portion of each of following systems, terminals, and/or devices (e.g., the system 1100, the system 1200, the system 1300, the system 1400, the system 1500, the system 1600, the terminal device 1700, the recognition device 2400, the processing engine 112) may be implemented on a computing device as illustrated in FIG. 2 or a mobile device as illustrated in FIG. 3.

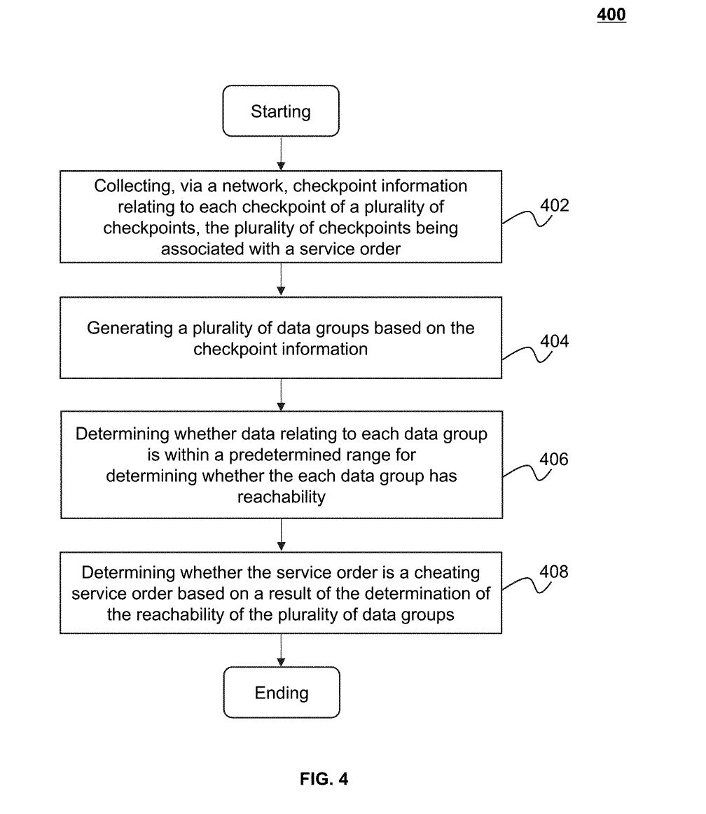

FIG. 4 is a flowchart of an exemplary process for examining a cheating service order according to a first embodiment of the present disclosure. As shown in FIG. 4, the process 400 for examining a cheating service order may include following steps.

In 402, checkpoint information relating to each checkpoint of a plurality of checkpoints may be collected. The plurality of checkpoints may relate to the service order.

In 404, a plurality of data groups may be generated based on the checkpoint information.

In 406, whether data relating to each data group of the plurality of data groups is within a predetermined range may be determined. Whether the each data group has reachability may be determined based on a result of the determination whether the data relating to the each data group of the plurality of data groups is within the predetermined range. The term “reachability” used herein refers to the ability of an entity (e.g., a vehicle, a person, a passenger, a driver) to move from a position to another within a time period and in a region both associated with a data group.

In 408, whether the service order is a cheating service order may be determined based on a result of the determination of the reachability of the plurality of data groups.

According to the process 400 for examining the cheating service order provided by the embodiment of the present disclosure, a series of data reflecting a status of the service order may be obtained by collecting the checkpoint information relating to each checkpoint and analyzing the checkpoint information. It may be determined that whether the service order is a cheating service order by determining the obtained data hierarchically, so that the corresponding rewards and subsidies may be canceled to reduce losses. On one hand, trajectories of the driver and the passenger cannot be compared directly since many terminal users refuse to show real-time location information in the background for privacy protection; on the other hand, there is no reachability between the driver and the passenger in both time and space since many service orders of the driver are appointed in advance and no passenger is picked up; that is, theoretically, one position of a checkpoint of an event in the service order cannot reach another position of a checkpoint of another event within a corresponding time. In the process provided by the embodiment of the present disclosure, the above two points have been considered, the status of the service order may be analyzed based on the checkpoint information uploaded by the driver and the passenger at several checkpoints of events when performing order operations to determine whether the travelling data of the service order has reachability. The reachability of the traveling data may be analyzed, so that the cheating service order may be found, in which the amount of calculation is small, and the examination result is reliable.

In some embodiments of the present disclosure, preferably, the checkpoint information relating to each checkpoint may include an event name, a time point, and a position coordinate. The position coordinates may be transmitted by a passenger terminal and/or a driver terminal to the server via a network. A positioning component (e.g., a global positioning system (GPS) chipset) in the passenger terminal and/or the driver terminal may obtain the position coordinates in real time. The positioning component may transmit the position coordinate to the processing engine 112. Each data group may include a time difference value, a distance value, and a speed value.

In some embodiments, the checkpoint information relating to each checkpoint may include the event name for maintenance personnel to verify the information. The checkpoint information may also include the time point and the position coordinates (usually a GPS position) for calculating the time difference value and the distance value to calculate the speed value, which facilitates reflecting the traveling status of the service order. Specifically, the event name may include passenger's initiating a service request, driver's acceptance of the service request, picking up of the passenger by the driver, start of the travelling, end of the travelling, passenger payment, passenger evaluation, passenger's initiating a subsequent service request, driver's acceptance of a subsequent service request next time, or the like.

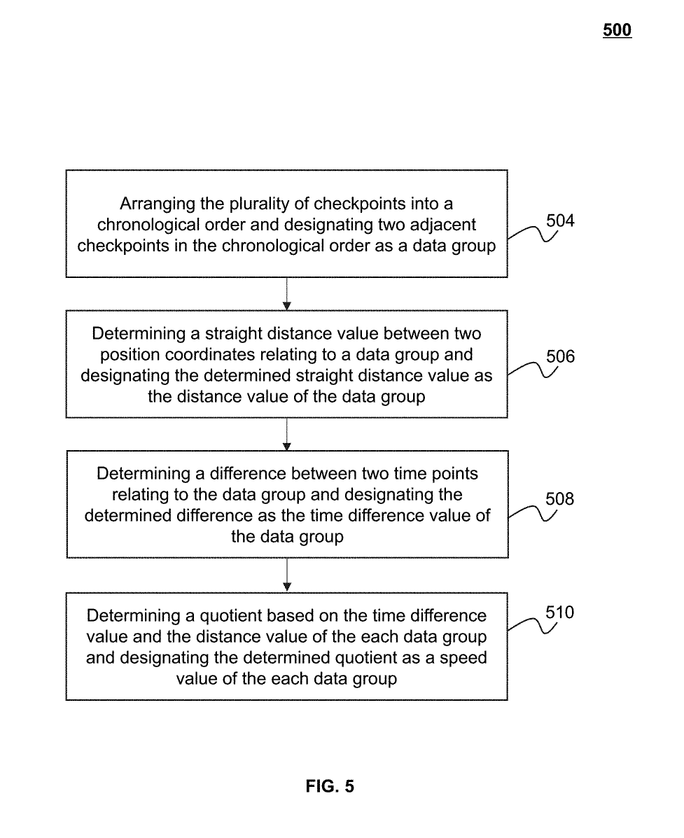

Specifically, FIG. 5 is a flowchart of an exemplary process for generating the data group in the embodiments described above in connection with FIG. 4.

In 502, the plurality of checkpoints may be arranged in chronological order. Two adjacent checkpoints in the chronological order may be designated as a checkpoint information group corresponding to a data group.

In 504, a straight distance value between two position coordinates relating to the each data group may be determined. The determined straight distance value may be designated as the distance value of the each data group.

In 506, a difference between two time points relating to the data group may be determined. Thee determined difference may be designated as the time difference value of the each data group.

In 508, a quotient may be determined based on the time difference value and the distance value of the each data group. The determined quotient may be designated as a speed value of the each data group.

In this embodiment, the process for generating the data group may be specifically defined. Firstly, the collected two adjacent checkpoints in the chronological order may be designated as a checkpoint information group. On one hand, a distance between two adjacent checkpoints is small, which may more realistically reflect the travelling status; on the other hand, after being grouped, a plurality of events may be dependent and there may be errors in timing when a service order is a sham service order, which has no reachability in both time and space and the service order can be examined, so that the accuracy and recognition of the examination may be improved. Then, the checkpoint information group may be calculated to obtain the corresponding data group.

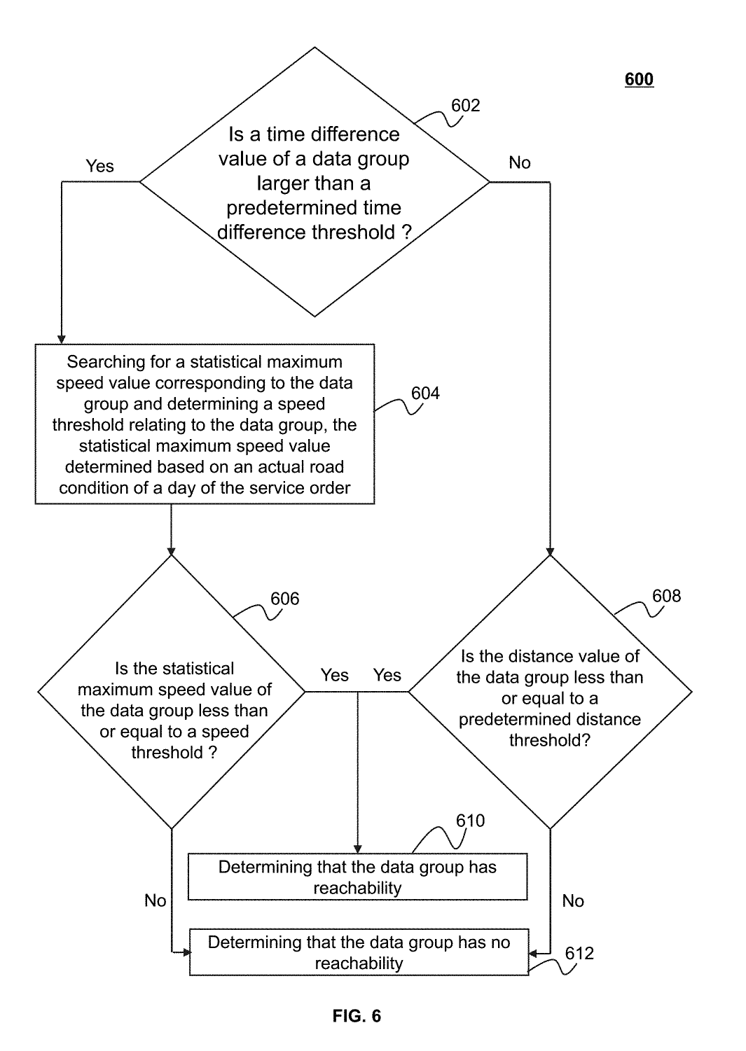

Specifically, FIG. 6 is a flowchart of an exemplary process for determining whether the data group has the reachability in the embodiments described above in connection with FIG. 4.

In 602, whether the time difference value of the each data group is larger than a first predetermined time difference threshold may be determined. If the time difference value of the each data group is larger than the first predetermined time difference threshold, step 604 may be performed. If the time difference value of the each data group is less than or equal to the first predetermined time difference threshold, step 608 may be performed.

A speed threshold relating to the each data group may be determined. In some embodiments, the statistical maximum speed value may be determined based on the actual road condition of the day of the service order.

In 606, whether the speed value of the data group is less than or equal to a speed threshold is determined. If the processing engine 112 determines that the speed value of the data group is less than or equal to the speed threshold, the process 600 may proceed to 610. If the processing engine 112 determines that the speed value of the data group is larger than the speed threshold, the process 600 may proceed to 612.

In 608, whether the distance value of the data group is less than or equal to a predetermined distance threshold may be determined. If the distance value of the data group is less than or equal to the predetermined distance threshold, operation 610 may be performed. If the distance value of the data group is larger than the predetermined distance threshold, operation 612 may be performed.

In 610, the processing engine 112 may determine that the each data group has reachability.

In 612, the processing engine 112 may determine that the each data group has no reachability.

In some embodiments, the process for determining whether the data group has reachability may be specifically defined. Since within a certain period of time in a certain region, space distance, traffic complexity, weather conditions, etc. will all restrict the fastest and shortest time from one place to another in reality, the full amount of data can be used to calculate the distribution of urban speed in both time and space. If the processing engine 112 determines that the speed of the passenger and the driver at each time period is larger than that of the actual distribution in a city in the course of traveling, the processing engine 112 determines that this service order may have no realistic reachability in both time and space. In a specific determination, the time difference value may be firstly determined, and a reasonable first predetermined time difference threshold may be chosen for each data group. The data groups may be classified into two cases and examined separately: one is a case where a certain distance is traveled, such as the data group corresponding to the travelling start and the travelling end; the other is a case of no travelling, such as the data group corresponding to the driver's picking up of the passenger and the travelling start. For the first case, the reachability of the data group may be determined by determining for the statistical result of the total traveling speed in the city and comparing the statistical result with the speed value relating to the data group. For the second case, the distance value may be compared with the predetermined distance threshed with no need of determining for the statistical result, and thus the amount of system operations is reduced reasonably.

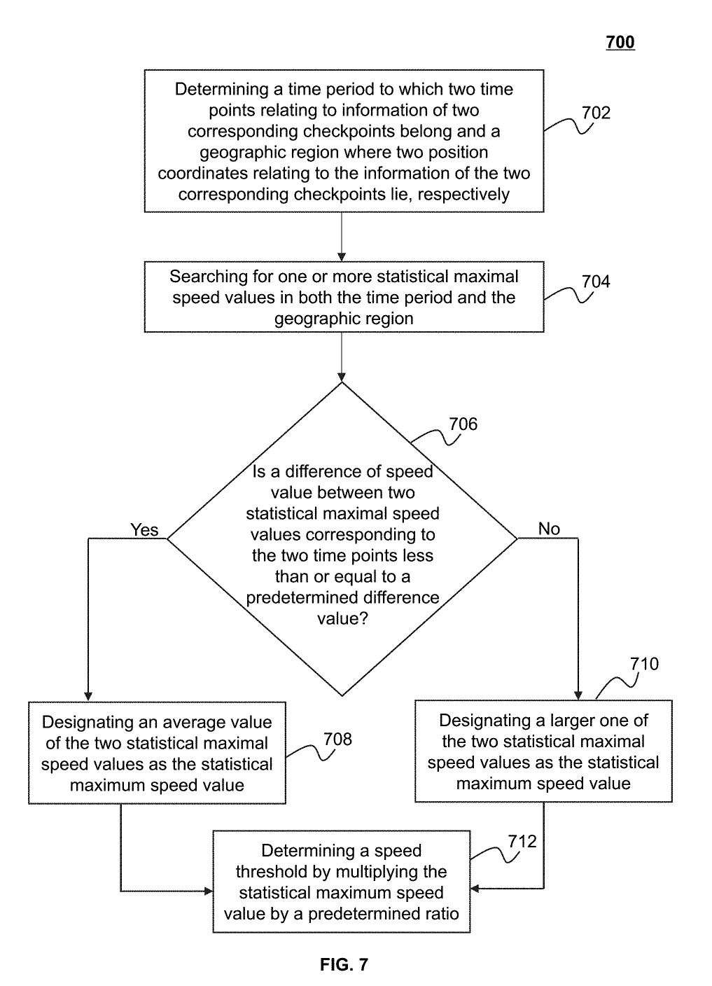

Specifically, FIG. 7 is a flowchart of an exemplary process for determining the speed threshold in the embodiments described above in connection with FIG. 6.

In 702, a time period and a geographic region may be determined. Two time points relating to information of two corresponding checkpoints may belong to the time period. Two position coordinates relating to the information of the two corresponding checkpoints may lie in the geographic region.

In 704, one or more statistical maximal speed values may be determined in both the time period and the geographic region.

In 706, whether the difference of speed value between two statistical maximal speed values corresponding to the two time points is less than or equal to a predetermined difference value may be determined. If the processing engine 112 determines that the difference of speed value is less than or equal to the predetermined difference value, the process 700 may proceed to 708. If the processing engine 112 determines that the difference of speed value is larger than the predetermined difference value, the process 700 may proceed to 710.

In 708, the average value of the two statistical maximal speed values may be designated as the statistical maximum speed value.

In 710, a larger one of the two statistical maximal speed values may be designated as the statistical maximum speed value; and

In 712, the speed threshold may be determined by multiplying the statistical maximum speed value by a predetermined ratio.

In some embodiment, the process for determining the speed threshold may be specifically defined. Since travelling speed of the city is statistically determined based on the time period and the geographic region, namely, the city is divided into a plurality of geographic regions and travelling speeds in each geographic region in different time periods may be statistically determined, wherein the time period may be pre-divided, such as morning and evening rush hours, daytime and night time, different checkpoint information may belong to different time periods or geographic regions. Therefore, time periods and geographic regions corresponding to information of two checkpoints may be determined firstly, and then the corresponding statistical maximum speed value may be determined. The statistical maximum speed value of the data group may also be determined. If the processing engine 112 determines that a difference value thereof is small, the processing engine 112 may designate the average value of the two statistical maximal speed values as the statistical maximum speed value to accurately reflect the actual traffic distribution. If the processing engine 112 determines that the difference value thereof is large, the processing engine 112 may designate the larger one of the two statistical maximal speed values as the statistical maximum speed value to avoid false determination. By multiplying the determined statistical maximum speed value by the predetermined ratio, a lager speed value due to positioning error may be compensated to avoid false determination and ensure the interests of users. In some embodiments, the predetermined ratio may be 20%.

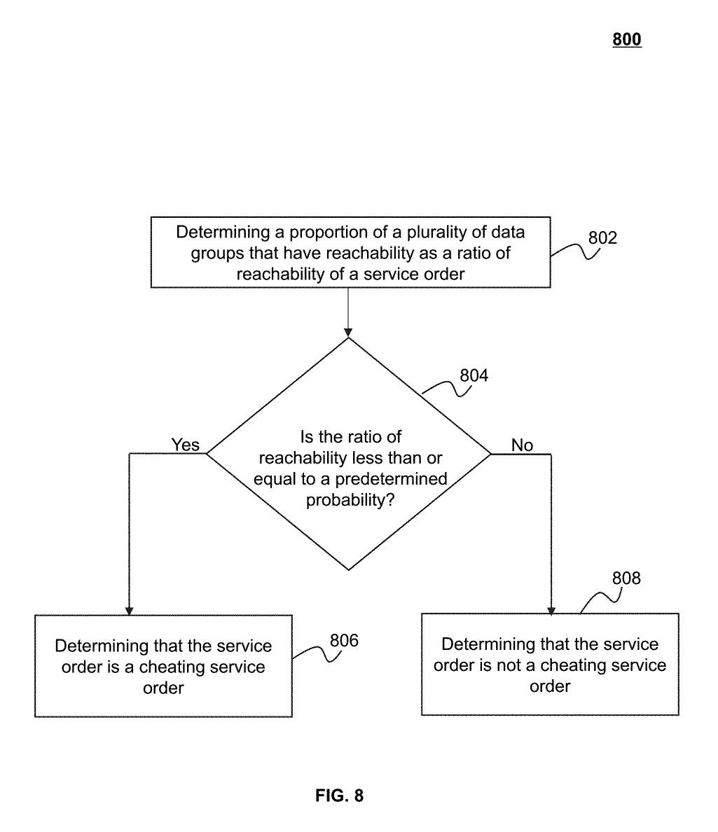

FIG. 8 is a flowchart of an exemplary process for determining whether the service order is a cheating service order in the embodiments described above in connection with FIG. 4.

In 802, a proportion of the plurality of data groups that have reachability may be determined as a ratio of reachability of the service order.

In 804, whether the ratio of reachability is less than or equal to a predetermined probability may be determined. If the processing engine 112 determines that the ratio of reachability is less than or equal to the predetermined probability, the process 800 may proceed to 806. If the processing engine 112 determines that the ratio of reachability is larger than the predetermined probability, the process 800 may proceed to 808.

In 806, the processing engine 112 may determine that the service order is a cheating service order.

In 808, the processing engine 112 may determine that the service order is not a cheating service order.

In some embodiments, the process for determining whether the service order is a cheating service order may be specifically defined. The determination results of the reachability of the plurality of data groups may be analyzed, and then the analyzed ratio of reachability may be compared with the predetermined probability to obtain an examination result. In view of unreachability, if the processing engine 112 determines that the speed larger than a normal traveling speed is present in the plurality of the service order, the processing engine 112 may determine that the service order has an event having unreachability in both time and space. If the processing engine 112 determines that this kind of events reach a certain proportion of the service order (a sum of the proportion and the predetermined probability is 1), the processing engine 112 may determine that the service order is a cheating service order. Specifically, the predetermined probability may be 80%.

In some embodiments of the present disclosure, preferably, collecting the checkpoint information relating to each checkpoint of the plurality of checkpoints may be specifically executed as collecting the checkpoint information from a passenger terminal and/or a driver terminal, and the checkpoint information may be determined by a positioning component (e.g., a GPS chipset) of the passenger terminal and/or driver terminal.

In some embodiments, the checkpoint information may be collected from the passenger terminal and/or the driver terminal at the same time and may be not distinguished. In a subsequent calculation, a distance value and a time difference value of a passenger and a driver, a distance value and a time difference value of the passenger in each event, and a distance value and a time difference value of the driver in each event may be obtained to obtain a plurality of data groups. Since various events of a service order are used, the events may be dependent, so that the difficulty of cheating may be improved, the examination may be facilitated, and the accuracy and recognition of the examination may be ensured.

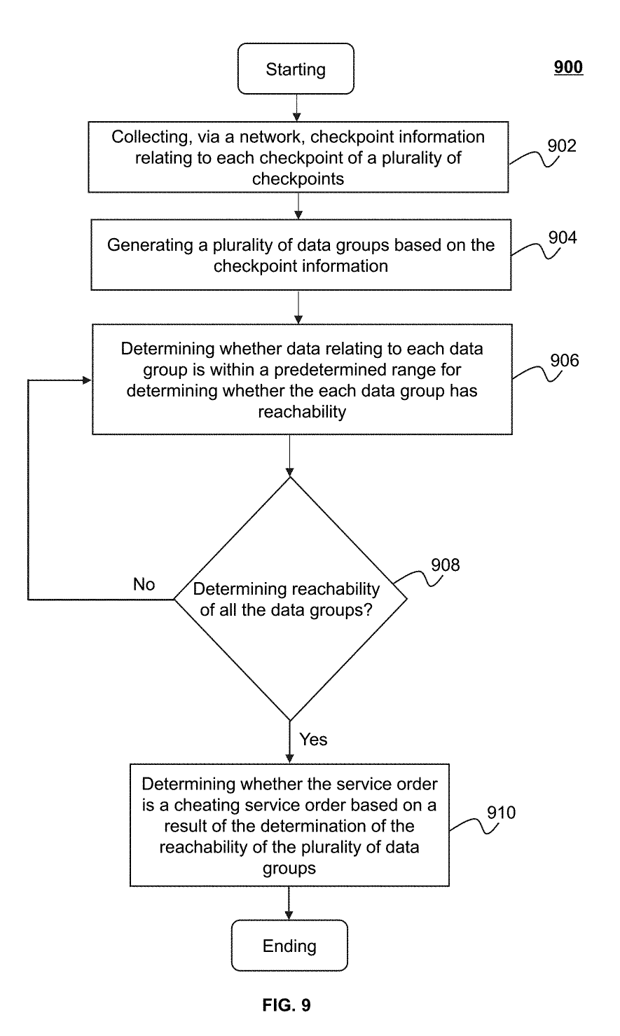

FIG. 9 is a flowchart of an exemplary process for examining a cheating service order according to some embodiments of the present disclosure. As shown in FIG. 9, the process 900 for examining a cheating service order may include following operations.

In 902, checkpoint information relating to each checkpoint of a plurality of checkpoints may be collected. The plurality of checkpoints may relate to the service order.

In 904, a plurality of data groups may be generated based on the checkpoint information.

In 906, whether data relating to each data group of the plurality of data groups is within a predetermined range may be determined. Whether the each data group has reachability may be determined based on a result of the determination whether the data relating to the each data group of the plurality of data groups is within the predetermined range.

In 908, whether reachability relating to all the plurality of data groups has been determined may be determined. If the processing engine 112 determines that the reachability relating to all the plurality of data groups has been determined, the process 900 may proceed to 910. If the processing engine 112 determines that the reachability relating to one of the plurality of data groups has not been determined, the process 900 may proceed to 906.

In 910, whether the service order is a cheating service order based on a result of the determination of the reachability of the plurality of data groups may be determined.

In some embodiments, the comprehensiveness of the examination may be ensured by determining whether reachability relating to all the plurality of data groups has been determined, so that the accuracy may be improved.

In some embodiments of the present disclosure, preferably, a number count of the plurality of checkpoints may be at least three.

In some embodiments, the number count of the checkpoints may be at least three. Since the number count of the data groups is one less than that of the checkpoints, the number count of the data groups may be at least two. Thus, a case where the property of a service order is determined based on only one data group may be avoided, so that sampling criteria may be improved and the reliability of the examination result may be ensured.

Next, the process for examining a cheating service order in the embodiment of the present disclosure will be described with two specific embodiments.

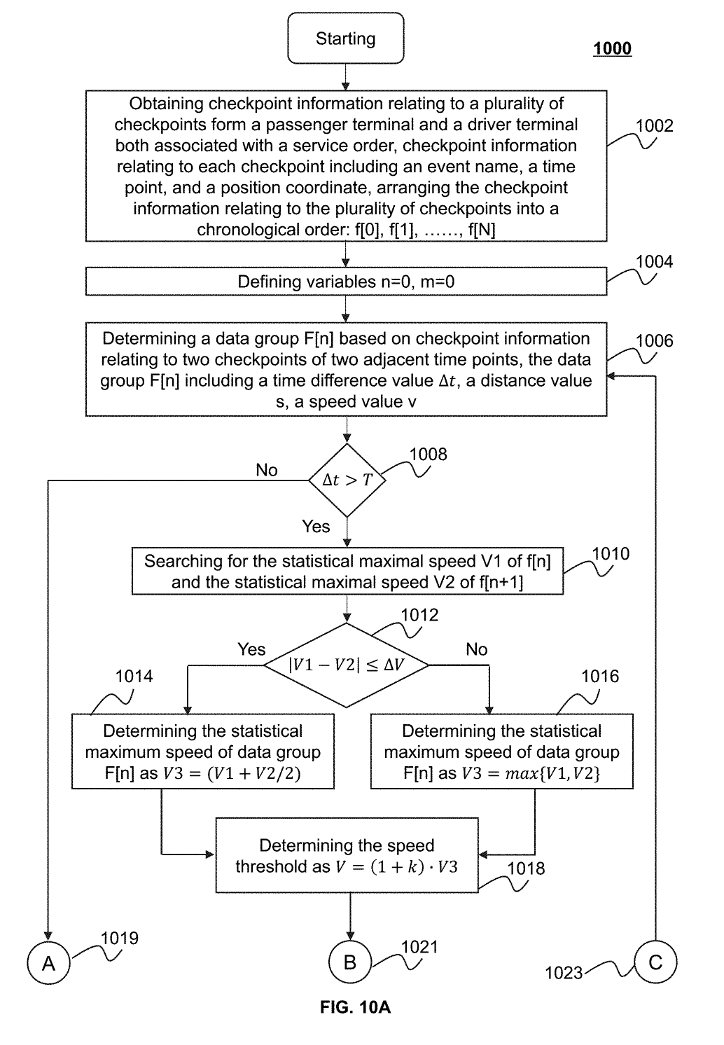

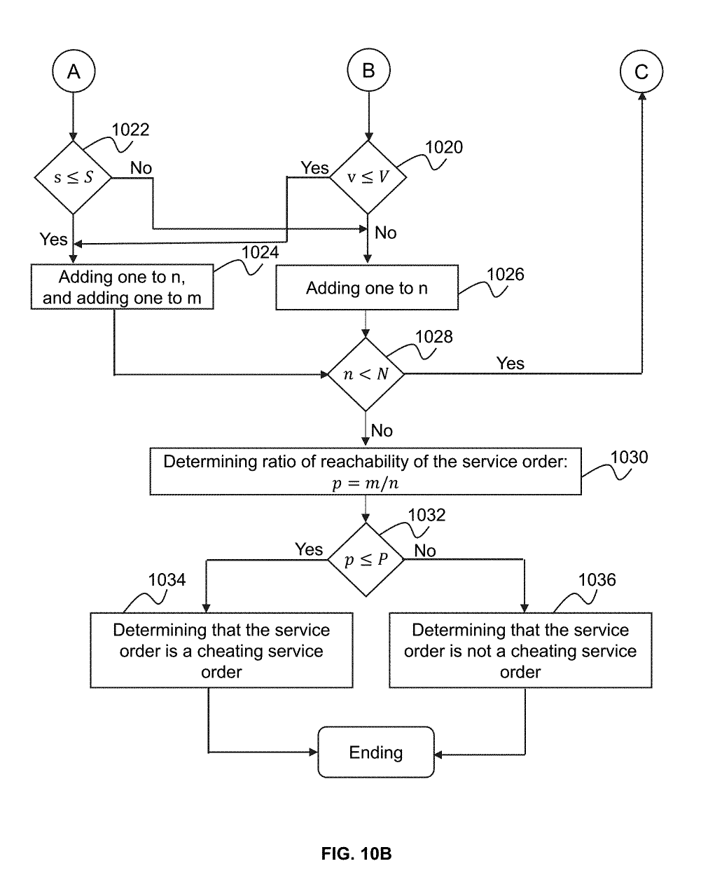

As shown in FIG. 10A and FIG. 10B, a process 1000 for examining a cheating service order according to some embodiments may include following operations.

In 1002, checkpoint information relating to each checkpoint of a plurality of checkpoints may be collected from a passenger terminal and/or a driver terminal. each checkpoint information may include an event name, a time point, and a position coordinate. The plurality of checkpoints may be arranged in chronological order as follows: f[0], f[1], . . . , f[N].

In 1004, variables that are m and n may be defined. The original values of m and n may be set as: n=0 and m=0.

In 1006, two adjacent checkpoints, f[n] and f[n+1], in the chronological order may be designated as a data group F[n]. The data group F[n] may include a time difference value Δt, a distance value s and a speed value v.

In 1008, whether Δt>T is satisfied may be determined. If the processing engine 112 determines that Δt>T is satisfied, the process 1000 may proceed to 1010. If the processing engine 112 determines that Δt≤T is satisfied, the process 1000 may proceed to operations illustrated in FIG. 10B starting from node A 1019.

In 1010, a statistical maximum speed value V1 corresponding to f[n] and a statistical maximum speed value V2 corresponding to the f[n+1] may be determined.

In 1012, whether |V1−V2|≤ΔV is satisfied may be determined. If the processing engine 112 determines that |V1−V2|≤ΔV is satisfied, the process 1000 may proceed to 1014. If the processing engine 112 determines that |V1−V2|>ΔV is satisfied, the process 1000 may proceed to 1016 may be performed.

In 1014, a statistical maximum speed value V3 of the data group F[n] may be determined as V3=(V1+V2)/2.

In 1016, a statistical maximum speed value V3 of the data group F[n] may be determined as V3=max{V1,V2}.

In 1018, a speed threshold V may be determined as V=(1+k)·V3, wherein k is a predetermined ratio.

In 1020, whether v≤V is satisfied may be determined. If the processing engine 112 determines that v≤V is satisfied, the process 1000 may proceed to 1024. If the processing engine 112 determines that v>V is satisfied, the process 1000 may proceed to 1026. Then, the process 1000 may proceed to operations illustrated in FIG. 10B starting from node B 1021.

In 1022, whether s≤S is satisfied may be determined, wherein S is a predetermined distance threshold. If the processing engine 112 determines that s≤S is satisfied, the process 1000 may proceed to 1024. If the processing engine 112 determines that s>S is satisfied, the process 1000 may proceed to 1026.

In 1024, 1 may be added to n, and 1 may be added to m.

In 1026, 1 may be added to n.

In 1028, whether n<N is satisfied may be determined. If the processing engine 112 determines that n<N is satisfied, the process 1000 may proceed to operations illustrated in FIG. 10A starting from node C 1023. If the processing engine 112 determines that n≥N is satisfied, the process 1000 may proceed to operation 1030.

In 1030, a ratio of reachability of the service order may be determined as p=m/n.

In 1032, whether p≤P is satisfied may be determined. If the processing engine 112 determines that p≤P is satisfied, the process 1000 may proceed to operation 1034. If p>P is satisfied, the process 1000 may proceed to 1036.

In 1034, the processing engine 112 may determine that the service order is a cheating service order.

In 1036, the processing engine 112 may determine that the service order is not a cheating service order.

In the first specific embodiment, every time a data group is generated, the reachability thereof may be determined. In a second specific embodiment, all data groups are generated and the reachability of each data group may be gradually determined. The detailed operations of the determination are not described here.

FIG. 11 is a schematic block diagram of a system for examining a cheating service order according to a first embodiment of the present disclosure. As shown in FIG. 11, the system 1100 for examining a cheating service order may include an acquisition module 1102, a calculation module 1104, a first judgment module 1106 and a second judgment module 1108.

The acquisition module 1102 may be configured to collect checkpoint information relating to each checkpoint of a plurality of checkpoints. The plurality of checkpoints may relate to the service order.

The calculation module 1104 may be configured to generate a plurality of data groups based on the checkpoint information.

The first judgment module 1106 may be configured to determine whether data relating to each data group of the plurality of data groups is within a predetermined range and determine whether the each data group has reachability based on a result of the determination whether the data relating to the each data group of the plurality of data groups is within the predetermined range.

The second judgment module 1108 may be configured to determine whether the service order is a cheating service order based on a result of the determination of the reachability of the plurality of data groups.

According to the system 1100 for examining the cheating service order provided by the embodiment of the present disclosure, a series of data reflecting a status of the service order may be obtained by the acquisition module 1102 and the calculation module 1104; and it may be determined whether the service order is a cheating service order by determining the obtained data hierarchically by the first judgment module 1106 and the second judgment module 1108, so that the corresponding rewards and subsidies may be cancelled to reduce losses. On one hand, trajectories of the driver and the passenger cannot be compared with each other directly since many terminal users refuse to show real-time location information in the background for privacy protection; on the other hand, there is no reachability between the driver and the passenger in both time and space since many service orders of the driver are appointed in advance and no passenger is picked up, that is, theoretically, one position of a checkpoint of an event in the service order cannot reach another position of a checkpoint of an event within a corresponding time. In the system provided by the embodiments of the present disclosure, the above two points have been considered, the status of the service order may be analyzed based on the checkpoint information uploaded by the driver and the passenger at several checkpoints of events when performing order operations to determine whether the travelling data of the service order has reachability. The reachability of the traveling data may be analyzed, so that the cheating service order may be found, in which the amount of calculation is small, and the examination result is reliable. Specifically, the acquisition module 1102 is connected to a communication device (e.g., the service requestor terminal 130, the service provider terminal 140, the computing device 200, the mobile device 300).

In some embodiments of the present disclosure, preferably, the checkpoint information relating to each checkpoint may include an event name, a time point, and a position coordinate, and each data group may include a time difference value, a distance value, and a speed value.

In some embodiments, the checkpoint information relating to each checkpoint may include the event name for maintenance personnel to verify the information. The checkpoint information may also include the time point and the position coordinates (usually a GPS position) for calculating the time difference value and the distance value to calculate the speed value, which facilitates reflecting the traveling status of the service order. Specifically, the event name may include passenger's initiating a service request, driver's acceptance of the service request, picking up of the passenger by the driver, start of the travelling, end of the travelling, passenger payment, passenger evaluation, passenger's initiating a subsequent service request, driver's acceptance of a subsequent service request next time, or the like.

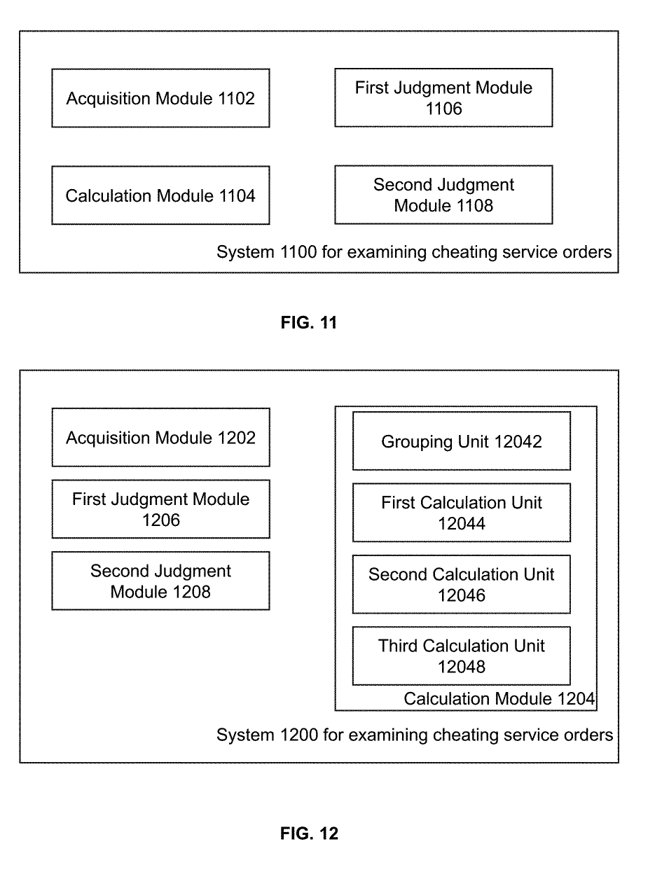

FIG. 12 is a schematic block diagram of a system for examining a cheating service order according to a second embodiment of the present disclosure. As shown in FIG. 12, the system 1200 for examining a cheating service order may include an acquisition module 1202, a calculation module 1204, a first judgment module 1206, and a second judgment module 1208.

The acquisition module 1202 may be configured to collect checkpoint information relating to each checkpoint of a plurality of checkpoints. The plurality of checkpoints may relate to the service order.

The calculation module 1204 may be configured to generate a plurality of data groups based on the checkpoint information. The calculation module 1204 including a grouping unit 12042, a first calculation unit 12044, a second calculation unit 12046, and a third calculation unit 12048.

The grouping unit 12042 may be configured to arrange the plurality of checkpoints in chronological order. The grouping unit 12042 may designate two adjacent checkpoints in the chronological order as a checkpoint information group corresponding to a data group.

The first calculation unit 12044 may be configured to determine a straight distance value between two position coordinates relating to the each data group. The first calculation unit 12044 may designate the determined straight distance value as the distance value of the each data group.

The second calculation unit 12046 may be configured to determine a difference between two time points relating to the data group. The second calculation unit 12046 may designate the determined difference as the time difference value of the each data group.

The third calculation unit 12048 may be configured to determine a quotient based on the time difference value and the distance value of the each data group. The third calculation unit 12048 may designate the determined quotient as a speed value of the each data group.

The first judgment module 1206 may be configured to determine whether data relating to each data group of the plurality of data groups is within a predetermined range. The first judgment module 1206 may determine whether the each data group has reachability based on a result of the determination whether the data relating to the each data group of the plurality of data groups is within the predetermined range.

The second judgment module 1208 may be configured to determine whether the service order is a cheating service order based on a result of the determination of the reachability of the plurality of data groups.

In some embodiments, the constitution of the calculation module 1204 may be specifically defined. The collected two adjacent checkpoints in the chronological order may be designated as a checkpoint information group by the grouping unit 12042. On one hand, the distance between two adjacent checkpoints is small, which may more realistically reflect the travelling status; on the other hand, after being grouped, a plurality of events may be dependent and there may be errors in timing when service orders are counterfeited, which makes no reachability in both time and space and the service orders can be examined, so that the accuracy and recognition of the examination may be improved. Then, the checkpoint information group may be calculated by the first calculation unit 12044, the second calculation unit 12046 and the third calculation unit 12048 to obtain the corresponding data group. Specifically, the first calculation unit 12044, the second calculation unit 12046 and the third calculation unit 12048 may be the same determination unit.

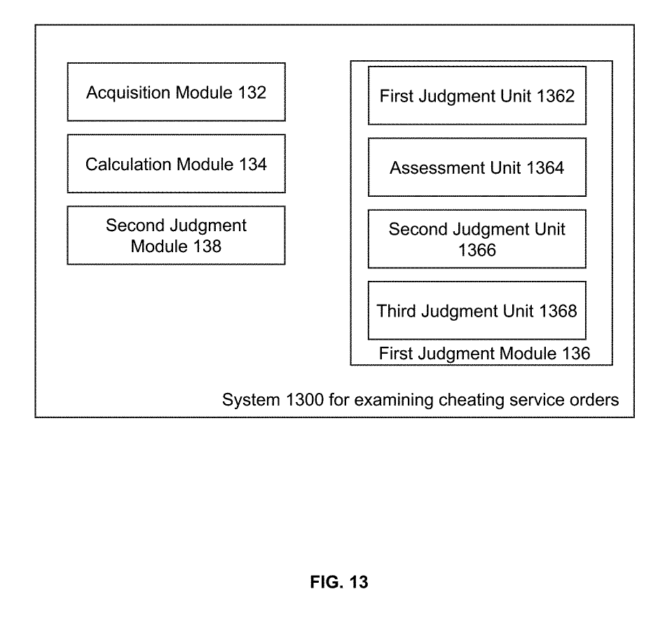

FIG. 13 is a schematic block diagram of a system for examining a cheating service order according to a third embodiment of the present disclosure. As shown in FIG. 13, the system 1300 for examining a cheating service order may include an acquisition module 132, a calculation module 134, a first judgment module 136 and a second judgment module 138.

The acquisition module 132 may be configured to collect checkpoint information relating to each checkpoint of a plurality of checkpoints. The plurality of checkpoints may relate to the service order.

The calculation module 134 may be configured to generate a plurality of data groups based on the checkpoint information.

The first judgment module 136 may be configured to determine whether data relating to each data group of the plurality of data groups is within a predetermined range. The first judgment module 136 may determine whether the each data group has reachability based on a result of the determination whether the data relating to the each data group of the plurality of data groups is within the predetermined range. The first judgment module 136 may include a first judgment unit 1362, an assessment unit 1364, a second judgment 1366, and a third judgment 1368.

The first judgment unit 1362 may be configured to determine whether a time difference value of the each data group is larger than a first predetermined time difference threshold.

The assessment unit 1364 may be configured to determine for a statistical maximum speed value corresponding to the each data group. If the determination result of the first judgment unit 1362 is yes, the assessment unit 1364 may determine a speed threshold relating to the each data group. The statistical maximum speed value may be determined based on an actual road condition of a day of the service order.

The second judgment unit 1366 may be configured to determine whether a speed value of the data group is less than or equal to a speed threshold. If the speed value of the data group is less than or equal to the speed threshold, the second judgment unit 1366 may determine that the data group has reachability.

If the time difference value of the each data group is less than or equal to the first predetermined time difference threshold, the third judgment unit 1368 may be configured to determine whether a distance value of the data group is less than or equal to a predetermined distance threshold. If the distance value of the data group is less than or equal to the predetermined distance threshold, the third judgment unit 1368 may determine that the data group has reachability.

The second judgment module 138 may be configured to determine whether the service order is a cheating service order based on a result of the determination of the reachability of the plurality of data groups.

In this embodiment, the constitution of the first judgment module 136 may be specifically defined. Since within a certain period of time in a certain region, space distance, traffic complexity, weather conditions, etc. will all restrict the fastest and shortest time from one place to another in reality, the full amount of data can be used to calculate the distribution of urban speed in both time and space. If the speed of the passenger and the driver at each time period is larger than that of the actual distribution in a city in the course of traveling, this service order may have no realistic reachability in both time and space. In specific determination, the time difference value may be firstly determined by the first judgment unit 1362, and a reasonable first predetermined time difference threshold may be chosen. The data groups may be classified into two cases and examined separately: one is a case where a certain distance is traveled, such as the data group corresponding to the travelling start and the travelling end; the other is a case of no travelling, such as the data group corresponding to the driver's picking up of the passenger and the travelling start. For the first case, reachability of the data group may be determined by determining for the statistical result of the total travelling speed in the city by the assessment unit 1364 and comparing, by the second judgment unit 1366, the statistical result with the speed value relating to the data group. For the second case, the distance value may be compared with the predetermined distance threshed by the third judgment unit 1368 without involving the assessment unit 1364, and thus the amount of system operations is reduced reasonably. Specifically, the first judgment unit 1362, the second judgment unit 1366 and the third judgment unit 1368 may be a same determination unit.

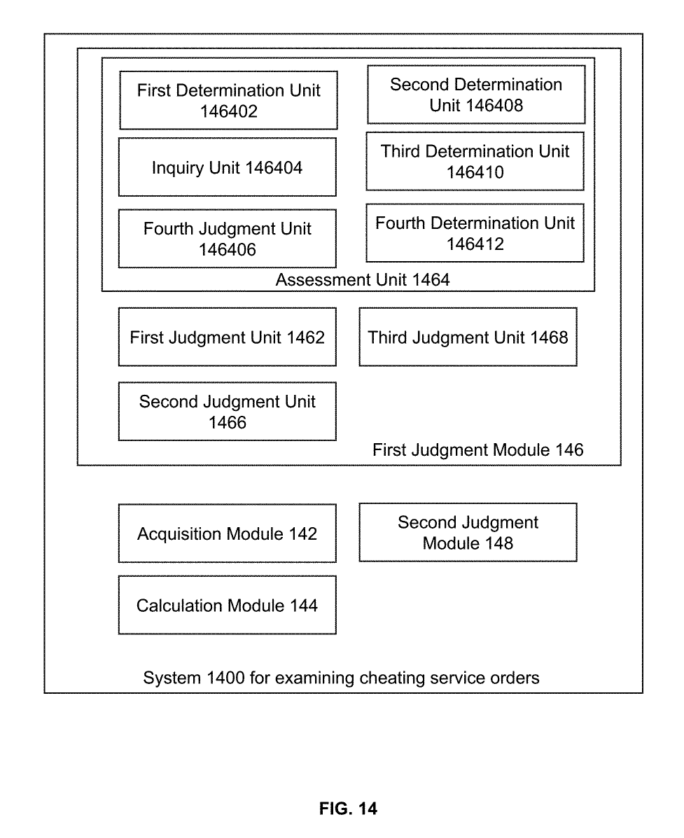

FIG. 14 is a schematic block diagram of a system for examining a cheating service order according to a fourth embodiment of the present disclosure. As shown in FIG. 14, the system 1400 for examining a cheating service order may include an acquisition module 142, a calculation module 144, a first judgment module 146 and a second judgment module 148.

The acquisition module 142 may be configured to collect checkpoint information relating to each checkpoint of a plurality of checkpoints. The plurality of checkpoints may relate to the service order.

The calculation module 144 may be configured to generate a plurality of data groups based on the checkpoint information.

The first judgment module 146 may be configured to determine whether data relating to each data group of the plurality of data groups is within a predetermined range. The first judgment module 146 may determine whether the each data group has reachability based on a result of the determination whether the data relating to the each data group of the plurality of data groups is within the predetermined range. The first judgment module may include a first judgment unit 1462, an assessment unit 1464, a second judgment unit 1466, a third judgment unit 1468.

The first judgment unit 1462 may be configured to determine whether a time difference value of the each data group is larger than a first predetermined time difference threshold.

The assessment unit 1464 may be configured to determine for a statistical maximum speed value corresponding to the each data group. If the time difference value of the each data group is larger than the first predetermined time difference threshold, the assessment unit 1464 may determine the speed threshold relating to the each data group. The statistical maximum speed value may be determined based on an actual road condition of a day of the service order. The assessment unit 1464 may include a first determination unit 146402, an inquiry unit 146404, a fourth judgment unit 146406, a second determination unit 146408, a third determination unit 146410, a fourth determination unit 146412.

The first determination unit 146402 may be configured to determine a time period and a geographic region, respectively. Two time points relating to information of two corresponding checkpoints may belong to the time period. Two position coordinates relating to the information of the two corresponding checkpoints may lie in the geographic region.

The inquiry unit 146404 may be configured to determine for one or more statistical maximal speed values in both the time period and the geographic region.

The fourth judgment unit 146406 may be configured to determine whether a difference of speed value between two statistical maximal speed values corresponding to the two time points is less than or equal to a predetermined difference value.

If the processing engine 112 determines that the difference of speed value between two statistical maximal speed values corresponding to the two time points is less than or equal to the predetermined difference value, the second determination unit 146408 may be configured to designate an average value of the two statistical maximal speed values as the statistical maximum speed value.

If the processing engine 112 determines that the difference of speed value between two statistical maximal speed values corresponding to the two time points is larger than the predetermined difference value, the third determination unit 146410 may be configured to designate a larger one of the two statistical maximal speed values as the statistical maximum speed value.

The fourth determination unit 146412 may be configured to determine the speed threshold by multiplying the statistical maximum speed value by a predetermined ratio.

The second judgment unit 1466 may be configured to determine whether a speed value of the data group is less than or equal to a speed threshold. If the speed value of the data group is less than or equal to the speed threshold, the second judgment unit 1466 may determine that the data group has reachability.

If the processing engine 112 determines that the time difference value of the each data group is less than or equal to the first predetermined time difference threshold, the third judgment unit 1468 may be configured to determine whether a distance value of the data group is less than or equal to a predetermined distance threshold. If the processing engine 112 determines that the distance value of the data group is less than or equal to the predetermined distance threshold, the third judgment unit 1468 may determine that the data group has reachability.

The second judgment module 148 may be configured to determine whether the service order is a cheating service order based on a result of the determination of the reachability of the plurality of data groups.

In this embodiment, the constitution of the assessment unit 1464 may be specifically defined. Since travelling speed of the city is statistically determined based on the time period and the geographic region. For example, a city is divided into a plurality of geographic regions and travelling speeds in each geographic region in different time periods may be statistically determined, wherein the time period is pre-divided, such as morning and evening rush hours, day time and night time. Different checkpoint information may belong to different time periods or geographic regions. Therefore, time periods and geographic regions corresponding to information of two checkpoints may be determined firstly by the first determination unit 146402, then the corresponding statistical maximum speed value may be determined by the assessment unit 146404, and then the statistical maximum speed value of the data group may be determined by the fourth judgment unit 146406, the second determination unit 146408 and the third determination unit 146410. If the processing engine 112 determines that the difference value thereof is small, the processing engine 112 may designate the average value of the two statistical maximal speed values as the statistical maximum speed value to accurately reflect the actual traffic distribution. If the processing engine 112 determines that the difference value thereof is large, the processing engine 112 may designate the larger one of the two statistical maximal speed values as the statistical maximum speed value to avoid false determination. By multiplying the determined statistical maximum speed value by the predetermined ratio by the fourth determination unit 146412, a lager speed value due to positioning error may be compensated to avoid false determination and ensure the interests of users. In some embodiments, the predetermined ratio may be 20%. Specifically, the first determination unit 146402, the second determination unit 146408, the third determination unit 146410 and the fourth determination unit 146412 may be the same determination unit.

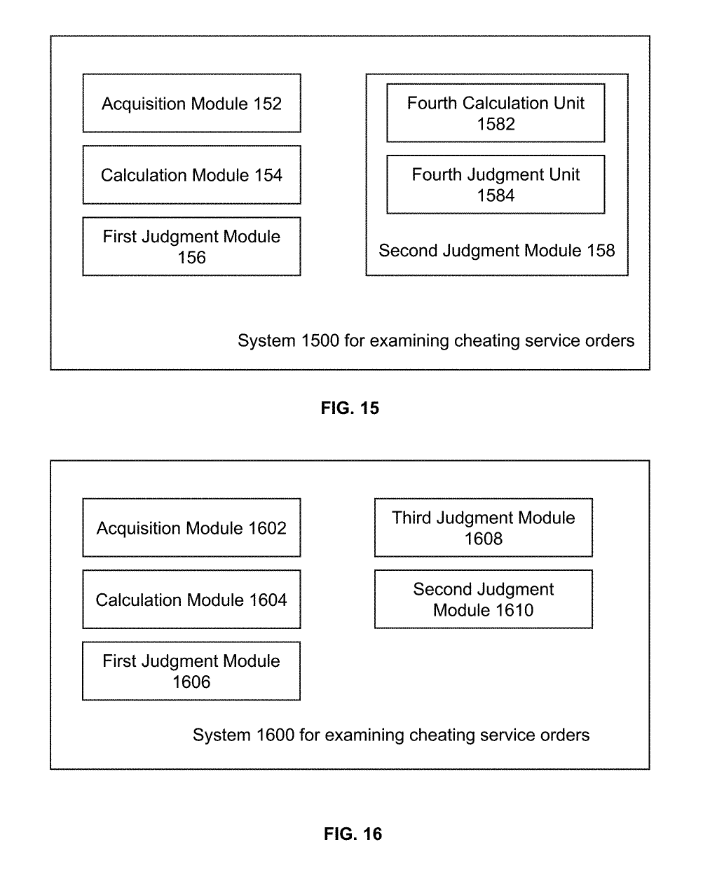

FIG. 15 is a schematic block diagram of a system for examining a cheating service order according to a fifth embodiment of the present disclosure. As shown in FIG. 15, the system 1500 for examining a cheating service order may include an acquisition module 152, a calculation module 154, a first judgment module 156 and a second judgment module 158.

The acquisition module 152 may be configured to collect checkpoint information relating to each checkpoint of a plurality of checkpoints. The plurality of checkpoints may relate to the service order.

The calculation module 154 may be configured to generate a plurality of data groups based on the checkpoint information.

The first judgment module 156 may be configured to determine whether data relating to each data group of the plurality of data groups is within a predetermined range. The first judgment module 156 may determine whether the each data group has reachability based on a result of the determination whether the data relating to the each data group of the plurality of data groups is within the predetermined range.

The second judgment module 158 may be configured to determine whether the service order is a cheating service order based on a result of the determination of the reachability of the plurality of data groups. The second judgment module 158 may include a fourth calculation unit 1582 and a fourth judgment unit 1584.

The fourth calculation unit 1582 may be configured to determine a proportion of the plurality of data groups that have reachability as a ratio of reachability of the service order.

The fourth judgment unit 1584 may be configured to determine whether a ratio of reachability of the data group is less than or equal to a predetermined probability. If the ratio of reachability of the data group is less than or equal to the predetermined probability, the fourth judgment unit 1584 may determine that the service order is a cheating service.

In this embodiment, the constitution of the second judgment module 158 may be specifically defined. The determination results of the reachability of the plurality of data groups of the first judgment module 156 may be analyzed by the fourth calculation unit 1582 and then the analyzed ratio of reachability may be compared with the predetermined probability by the fourth judgment unit 1584 to obtain an examination result. In view of unreachability, If the processing engine 112 determines that the speed larger than a normal travelling speed is present in the plurality of the service order, the processing engine 112 may determine that the service order has an event having unreachability in both time and space. If the processing engine 112 determines that this kind of events reach a certain proportion of the service order (a sum of the proportion and the predetermined probability is 1), the processing engine 112 may determine that the service order is a cheating service order. Specifically, the predetermined probability may be 80%.

In some embodiments of the present disclosure, preferably, the acquisition module may be specifically configured to collect the checkpoint information from a passenger terminal and a driver terminal.

In some embodiments, the checkpoint information may be collected from the passenger terminal and/or the driver terminal at the same time and may be not distinguished. In a subsequent calculation, a distance value and a time difference value of a passenger and a driver, a distance value and a time difference value of the passenger in each event, and a distance value and a time difference value of the driver in each event may be obtained to obtain a plurality of data groups. Since various events of a service order are used, the events are dependent, so that the difficulty of cheating may be improved, the examination may be facilitated, and the accuracy and recognition of the examination may be ensured.

FIG. 16 is a schematic block diagram of an exemplary system for examining a cheating service order according to some embodiments of the present disclosure. As shown in FIG. 16, the system 1600 for examining a cheating service order may include an acquisition module 1602, a calculation module 1604, a first judgment module 1606, a second judgment module 1610, and a third judgment module 1608.

The acquisition module 1602 may be configured to collect checkpoint information relating to each checkpoint of a plurality of checkpoints. The plurality of checkpoints may relate to the service order.

The calculation module 1604 may be configured to generate a plurality of data groups based on the checkpoint information.

The first judgment module 1606 may be configured to determine whether data relating to each data group of the plurality of data groups is within a predetermined range. The first judgment module 1606 may determine whether the each data group has reachability based on a result of the determination whether the data relating to the each data group of the plurality of data groups is within the predetermined range.

The third judgment module 1608 may be configured to determine whether reachability relating to all the plurality of data groups has been determined. If reachability relating to all the plurality of data groups has been determined, the second judgment module 1610 may be activated. If reachability relating to one of the plurality of data groups has not been determined, the first judgment module 1606 may be activated.

The second judgment module 1610 may be configured to determine whether the service order is a cheating service order based on a result of the determination of the reachability of the plurality of data groups.

In some embodiments, the comprehensiveness of the examination may be ensured by determining whether reachability relating to all the plurality of data groups has been determined by adding the third judgment module 1608, so that the accuracy may be improved.

In some embodiments of the present disclosure, preferably, a number count of the plurality of checkpoints may be at least three.

In some embodiments, the number count of the checkpoints may be at least three. Since the number count of the data groups is one less than that of the checkpoints, the number count of the data groups may be at least two. Thus, a case where the property of a service order is determined based on only one data group may be avoided, so that sampling criteria may be improved and the reliability of the examination result may be ensured.

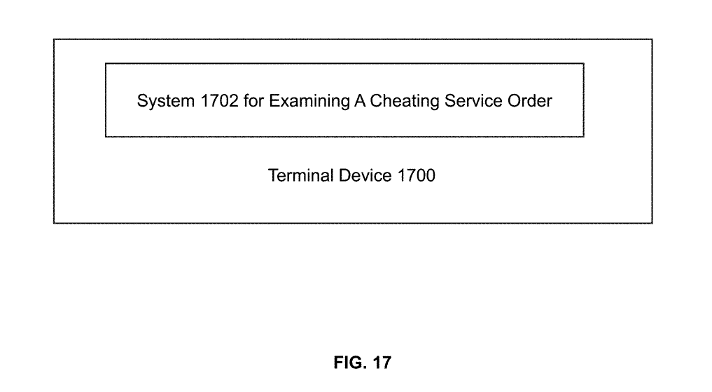

FIG. 17 is a schematic block diagram of a terminal device according to some embodiments of the present disclosure. As shown in FIG. 17, the terminal device 1700 may include a system 1702 for examining a cheating service order according to any one of the above embodiments.

The terminal device 1700 provided by the embodiment of the present disclosure may include the system 1702 for examining a cheating service order according to any one of the above embodiments and thus has all the beneficial technical effects of the system 1702 for examining a cheating service order, which will not be described herein.

Some embodiments of the present disclosure may provide a computer-readable storage medium. A computer program may be stored in the computer-readable medium. If the processing engine 112 determines that the computer program is executed by a processor, the processing engine 112 may perform the operations of the process described in any of the above embodiments.

In the computer-readable storage medium provided by the embodiment of the present disclosure, if the processing engine 112 determines that the computer program stored is executed by the processor, the processing engine 112 may perform the operations of the process described in any of the above embodiments, so that all the beneficial technical effects of the process for examining a cheating service order may be possessed, and will not be described herein.

The technical solutions of embodiments of the present disclosure are described in detail above with reference to the accompanying drawings. The embodiments of the present disclosure may provide technical solutions for examining a cheating service order, in which the full amount of data may be used to calculate actual traffic distribution of each region in the city in each time period to analyze reachability of both time and space of a service order. Since the cheater lacks the real-time data of the actual traffic conditions, and thus the distance value and the time difference value of a sham service order at a checkpoint of an event may be erroneous, making unreachability of the time and space. Therefore, the determination may be more accurate.

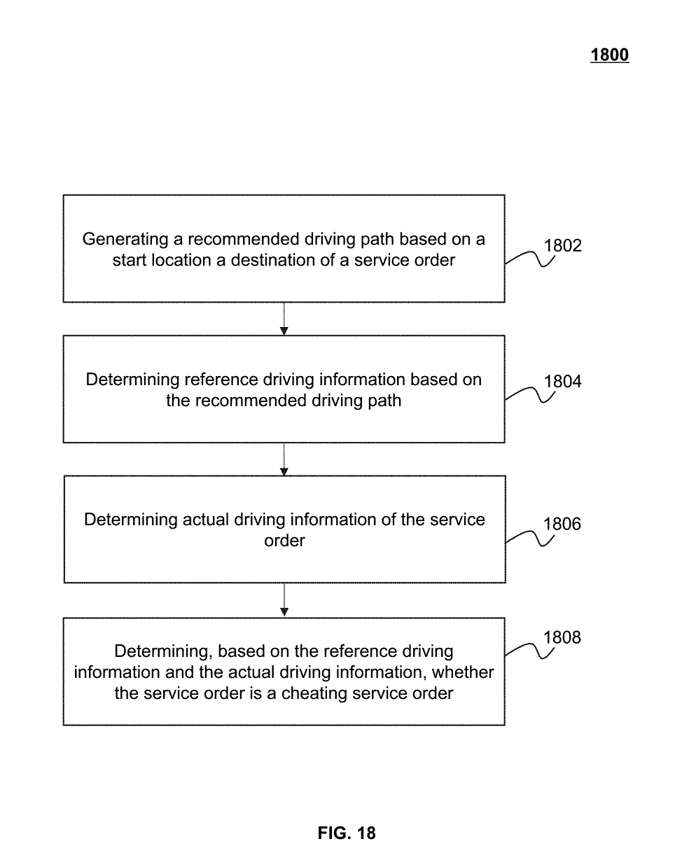

FIG. 18 is a flowchart of an exemplary process for recognizing a cheating service order in a scenario of online car-hailing according to some embodiments of the present disclosure.

Referring to FIG. 18, take the process for recognizing a cheating service order in the scenario of online car-hailing as an example, the process may include the following operations. The process 1800 may be applied in an online car-hailing platform (e.g., the online-to-offline service system 100, the processing engine 112).

In 1802, a start location and a destination of a service order may be obtained. A recommended driving path may be determined based on the start location and the destination.

In some embodiments, the online car-hailing platform may obtain the start location and the destination of a service order accepted by a driver and may generate the recommended driving path based on the start location and the destination. For example, the recommended driving path may be generated by calling a map API, which may reference prior art, and will not be described in the present disclosure.

In 1804, reference driving information may be determined based on the recommended driving path.

In some embodiments, the reference driving information may be used to be compared with actual driving information corresponding to the service order. The reference driving information may be also used to determine whether the service order is a cheating service order. The reference driving information may include a reference time period during which an acceleration equals a first predetermined value, and a reference driving trail corresponding to one of a plurality of segments of the recommended driving path.

In 1806, actual driving information of the service order may be determined.

In some embodiments, the online car-hailing platform may receive various driving data uploaded by a driver terminal in the process for completing the service order. The online car-hailing platform may determine the actual driving information corresponding to the service order based on the driving data. For example, the online car-hailing platform may determine an actual time period during which the acceleration equals the first predetermined value.

In 1808, whether the service order is a cheating service order may be determined based on the reference driving information and the actual driving information.

As can be seen from the above, in the present disclosure, the reference driving information may be determined based on the recommended driving path, and then whether the service order is a cheating service order may be determined based on the comparison result of the actual driving information of the driver and the reference driving information. Therefore, a cheating service order may be recognized effectively and accurately.

Hereinafter, an implementation process for the present disclosure will be described by taking the following as examples: the reference driving information is the reference time period during which the acceleration equals the first predetermined value, or the reference driving trail corresponding to each of a plurality of segments of the recommended driving path.

The reference driving information may include the reference time period during which the acceleration equals the first predetermined value.

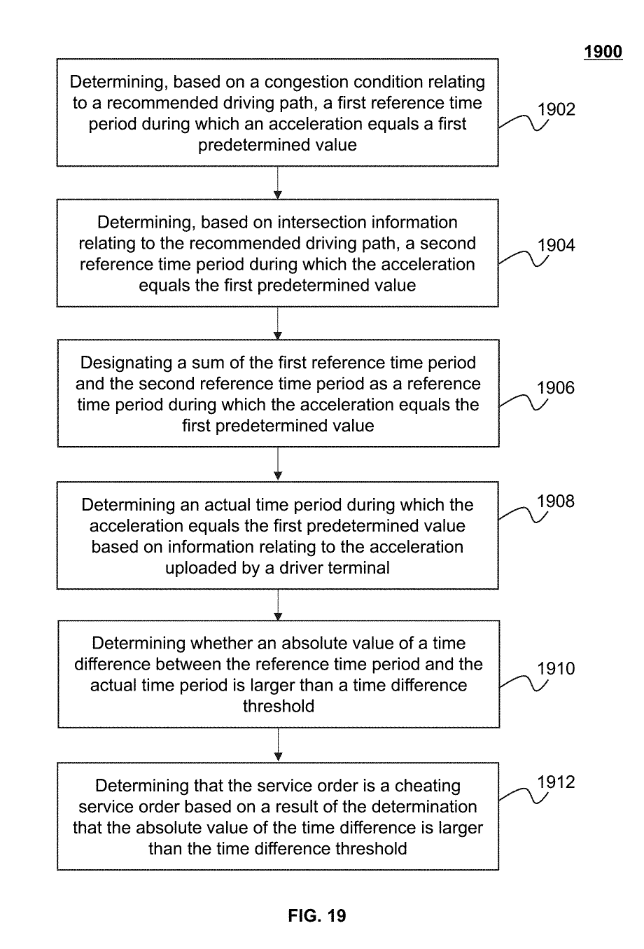

Referring to FIG. 19, a process for recognizing a cheating service order in a scenario of online car-hailing according to this embodiment may include the following operations.

In 1902, a first reference time period during which the acceleration equals the first predetermined value may be determined based on a congestion condition relating to the recommended driving path.

In some embodiments, the first predetermined value may be set by developers, and the description hereinafter may be made with the first predetermined value being 0 as an example. Of course, the first predetermined value may be other values. For example, the first predetermined value may be a small value.

In some embodiments, if the processing engine 112 determines that the acceleration is a small value (e.g., 0), the processing engine 112 may identify two cases: a stationary state and a constant speed driving state. Since the speed of the car may be influenced by road conditions, traffic conditions in practical applications, it may be difficult for the car to drive in a constant speed driving state. Therefore, if the processing engine 112 determines that the acceleration is 0, the processing engine 112 may determine that the car is in the stationary state.

In some embodiments, a time period during which the acceleration is 0 due to congestion during a process for completing the service order by the driver may be determined based on the congestion condition relating to the recommended driving path. For the ease of distinction, this time period may be referred to herein as the first reference time period in the present disclosure.

For example, if the processing engine 112 determines that the recommended driving path is free from congestion, the processing engine 112 may usually determine that the first reference time period is 0.

Alternatively or additionally, if the processing engine 112 determines that the recommended driving path has 500 meters of congestion, the processing engine 112 may determine the first reference time period based on a congestion level and the length of the congested road. For example, if the processing engine 112 determines that the 500 meters of congestion has a slight congestion level (corresponding to slow driving), the processing engine 112 may determine that the first reference time period may be 0. As another example, if the processing engine 112 determines that the 500 meters of congestion has a severe congestion level, the processing engine 112 may determine the first reference time period based on a traffic speed rate of the congested road.

It should be noted that, since the congestion condition of the road usually changes with time, in order to ensure the accuracy of the first reference time period, a reference time period of a path that has not been passed and during which the acceleration is 0 may be re-calculated to update the first reference time period. For example, the first reference time period may be re-calculated periodically.

In 1904, a second reference time period during which the acceleration equals the first predetermined value may be determined based on intersection information (e.g., traffic lights at intersections, estimated waiting time due to traffic lights at intersections) relating to the recommended driving path.

In some embodiments, the intersection information relating to the recommended driving path may include a time period of red light. If the processing engine 112 determines that there is no traffic light in a certain intersection, the processing engine 112 may determine that the time period of red light is 0.

In some embodiments, a time period during which the acceleration is 0 due to the red light in the process for driving through the recommended driving path may be determined based on the intersection information relating to the recommended driving path. For the ease of distinction, this time period may be referred herein to as the second reference time period in the present disclosure.

For example, a sum of the time period of red light relating to each intersection may be designated as the second reference time period. Of course, in the process for practical driving, there is a low probability of encountering a red light at each intersection, so that the sum of the time period of red light relating to each intersection may be multiplied by a predetermined proportion to obtain the second reference time period. For example, the predetermined proportion may be 0.7 or 0.8, or the like.

In 1906, a sum of the first reference time period and the second reference time period may be designated as the reference time period during which the acceleration equals the first predetermined value.

In some embodiments, if the processing engine 112 determines that the first reference time period is 2 minutes and the second reference time period is 5 minutes, the processing engine 112 may determine that the reference time period during which the acceleration is 0 is 7 minutes.

In 1908, the actual time period during which the acceleration equals the first predetermined value may be determined based on information relating to acceleration uploaded by a driver terminal.

In some embodiments, during the process for completing the service order by the driver terminal, the acceleration of the driver terminal may be obtained from a sensor of the driver terminal and sent to the online car-hailing platform. For example, by embedding a program, the driver terminal may obtain the acceleration periodically (for example, 5 seconds, 8 seconds, etc.). Since the terminal such as a mobile phone is usually put in a vehicle in the course of vehicle driving, the acceleration of the driver terminal may also represent the acceleration of the vehicle.

The online car-hailing platform may determine the actual time period during which the acceleration is 0 based on the acceleration periodically uploaded by the driver terminal. For example, if the processing engine 112 determines that the period of uploading the acceleration is 5 seconds, the acceleration uploaded by the driver terminal at 0 second is 0, the acceleration uploaded by the driver terminal at the 5th second is 0, and the acceleration uploaded by the driver terminal at the 10th second is not 0, the processing engine 112 may determine that the actual time period during which the acceleration is 0 is at least 5 seconds in 0 to 10 seconds. Of course, in practical applications, the actual time period during which the acceleration is 0 may be determined by other processes based on the acceleration uploaded by the driver terminal.

In some embodiments, since the information relating to the acceleration is obtained by the driver terminal from the sensor of the driver terminal and is high in accuracy, problems that the cheating service orders cannot be recognized due to malware simulation speed and other driving data may be effectively avoided.

In 1910, whether an absolute value of a time difference between the reference time period and the actual time period during which the acceleration equals the first predetermined value is larger than a second predetermined time difference threshold may be determined. If the processing engine 112 determines that the absolute value of the time difference is larger than the second predetermined time difference threshold, the process 1900 may proceed to 1912.

In some embodiments, the time difference between the reference time period and the actual time period during which the acceleration is 0 may be determined. The absolute value of the time difference may be compared with the second predetermined time difference threshold. If the processing engine 112 determines that a service order is a true order, and the driver carries out the service order according to a recommended driving path, the processing engine 112 may determine that there is a few time difference between the actual time period during which the acceleration is 0 and the reference time period. If the processing engine 112 determines that the time difference is large, the processing engine 112 may determine that that the time during which the vehicle is in the stationary state is long, which can be determined as abnormal. There may be a possibility that the driver may cheat for subsidies by the cheating service order without carrying out the order in practice.

Therefore, in this operation, if the processing engine 112 determines that the absolute value of the time difference is less than or equal to the second predetermined time difference threshold, the processing engine 112 may determine that the driver has carried out the service order and the service order is not a cheating service order. If the processing engine 112 determines that the absolute value of the time difference is larger than the second predetermined time difference threshold, the process 1900 may proceed to 1912.

In some embodiments, the second predetermined time difference threshold may be set by developers, or may be fixed values. For example, the second predetermined time difference threshold may be 10 minutes or 20 minute. The second predetermined time difference threshold may also be a dynamic value. For example, the second predetermined time difference threshold may be positively correlated with driving time. If the processing engine 112 determines that the driving time is long, the absolute value of the time difference between the reference time period and the actual time period during which the acceleration is 0 may be large, the processing engine 112 may set a large second predetermined time difference threshold. If the processing engine 112 determines that the driving time is short, and the absolute value of the time difference between the reference time period and the actual time period during which the acceleration is 0 may be small. the processing engine 112 may set a small second predetermined time difference threshold.

In 1912, the processing engine 112 may determine that the service order is a cheating service order.

Based on the determination result of operation 1910, if the processing engine 112 determines that the absolute value of the time difference between the reference time period and the actual time period during which the acceleration equals the first predetermined value is larger than the second predetermined time difference threshold, the processing engine 112 may determine that the corresponding service order may as a cheating service order. The online car-hailing platform may adopt corresponding measures. For example, the measures may include marking of the driver negatively, canceling of the award of the service order, etc.

As can be seen from the above, in the present disclosure, a cheating service order may be determined based on the acceleration obtained from the sensor of the driver terminal. Since the acceleration data in the sensor is not easily simulated by a cheat software, the process for determining a cheating service order provided by the present disclosure may have high accuracy. Therefore, a cheating service order can be recognized effectively and accurately.

It should be noted that if the online car-hailing platform generates a recommended driving path for a service order, the driver may not drive according to the recommended driving path in practical applications. According to the related technologies, if the processing engine 112 determines that the driver deviates from the recommended driving path, the processing engine 112 may re-design a new path. However, the recommended driving path for determining the reference information may be a recommended driving path matched with an actual driving path of the driver. The recommend driving path may be not necessarily a recommended driving path generated firstly based on the start location and the destination, and may be a driving path obtained after re-designing based on the actual driving path of the vehicle.

The order of performing operation 1902, operation 1904, and operation 1908 is not limited in this embodiment. In another embodiment, the online car-hailing platform may perform the operation 1904 firstly.

The reference driving information may be the reference driving trail corresponding to each of a plurality of segments of the recommended driving path.

At present, some cheat software may simulate a driving path of a service order, so that difficulty in recognizing a cheating service order for an online car-hailing platform may be increased. The driving path simulated by the cheating software may be matched with the shape of the actual path. For example, if the driving path is a straight line, the driving path simulated by the cheating software may also be a straight line. However, in practical applications, the driving trail of a vehicle may not be a straight line exactly even in a straight road, due to factors of cutting lines and overtaking. Therefore, the cheating service order may be recognized based on the reference driving trail of the driving trail coordinates and path uploaded by the driver terminal.

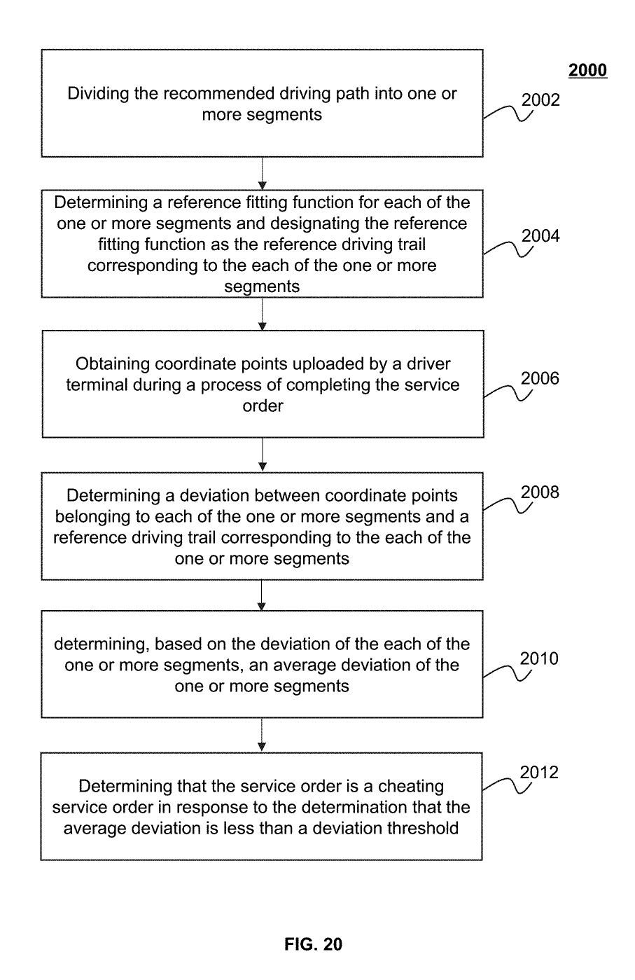

Referring to FIG. 20, a process for recognizing a cheating service order in a scenario of online car-hailing according to this embodiment may include the following operations.

In 2002, the recommended driving path may be divided into one or more segments.

In some embodiments, the generated recommended driving path may usually be a set of a plurality of coordinate points. In dividing the segments, three adjacent points may be selected, an angle between vectors formed by a middle point and the other two points may be determined. Whether the three points are divided into the same segment may be determined based on the angle.

Referring to the example in FIG. 21, it may be assumed that Point A, Point B, and Point C are the three adjacent points in the recommended driving path, an angle between a Vector AB and a Vector BC may be determined based on the position coordinates of Point A, Point B, and Point C.

If the processing engine 112 determines that the angle is larger than a predetermined angle, the processing engine 112 may determine that Point A, Point B, and Point C belong to the same segment. In the example of FIG. 21, the angle between Vector AB and Vector BC is 180 degrees, which is larger than the predetermined angle, so that Point A, Point B, and Point C may be determined to belong to the same segment.

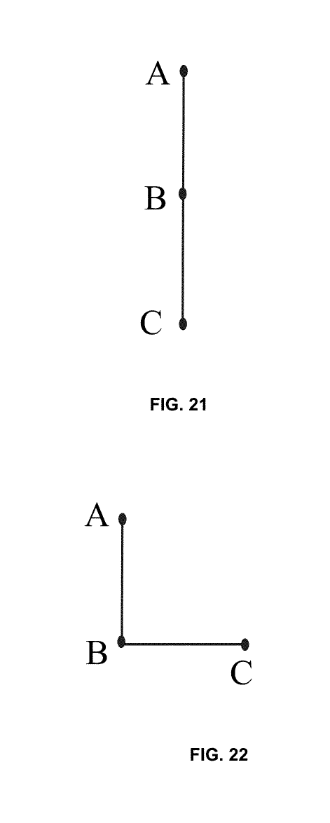

If the processing engine 112 determines that the angle is less than the predetermined angle, the processing engine 112 may determine that Point A, Point B, and Point C belong to different segments. Point A, Point B, and Point C may be made with Point B as a turning point. Point A and Point C may be divided into different segments. Of course, segmentation may be made with Point A or Point C as a turning point. In the example of FIG. 22, the angle between the Vector AB and the Vector BC is 90 degrees, which is less than the predetermined angle so that Point A, Point B, and Point C are determined to belong to different segments, and then segmentation is made.

The predetermined angle may be set by developers based on the actual road condition. The predetermined angle may be 120 degrees or 135 degrees.

Of course, the recommended driving path may be divided by other processes.

In 2004, for each of the one or more segments, a reference fitting function relating to the each of the one or more segments may be determined. The reference fitting function may be designated as the reference driving trail corresponding to the each of the one or more segments.

Based on the operation 2002, after diving the recommended driving path, the fitting function relating to each point in the each of the one or more segments may be determined for each of the one or more segments, that is, the fitting function may be generated based on the each point in the each of the one or more segments. The fitting function may be designated as the reference driving trail corresponding to the each of the one or more segments.

In some embodiments, the fitting function may be determined by using a least square method, a Bessel algorithm, or the like.

Based on this method, a reference driving trail may be generated for the each of the one or more segments of the recommended driving path. If the processing engine 112 determines that the recommended driving path may include four segments, the processing engine 112 may generate four reference driving trails correspondingly.

In 2006, coordinate points uploaded by a driver terminal during a process for completing the service order may be obtained.

In some embodiments, during a process for completing the service order by the driver terminal, the coordinate points of the terminal may be obtained and sent to the online car-hailing platform. For example, by embedding a program, the driver terminal may obtain and upload the coordinate points periodically (for example, 5 seconds, 8 seconds, etc.).

In 2008, for each of the one or more segments, a deviation between coordinate points belonging to the each of the plurality of segments and a reference driving trail corresponding to the each of the plurality of segments may be determined.

Based on the operations 2004 and 2006, the online car-hailing platform may, for each of the one or more segments, determine a coordinate point belonging to the each of the plurality of segments and a deviation corresponding to the reference driving trail.

In some embodiments, for a coordinate point uploaded by the driver terminal, the segment to which this coordinate point belongs may be determined firstly, and then the deviation may be determined.

For example, the process for determining the segment to which a coordinate point belongs may refer to the process for dividing the recommended driving path in operations 2002 and 2004. Namely, the coordinate points uploaded by the driver terminal may be divided to divide an actual driving path uploaded by the driver terminal into one or more segments. The divided segments may be matched with the segments of the recommended driving path.

Alternatively or additionally, for a coordinate point uploaded by the driver terminal, a point closest to the coordinate point on the recommended driving path may be determined. The segment to which Point belongs may be designated as the segment to which the coordinate point uploaded by the driver terminal belongs.

Of course, the segment to which the coordinate point uploaded by the driver terminal belongs may be determined by other processes. The present disclosure is not limiting

In some embodiments, a distance between a coordinate point and a reference driving trail corresponding to a segment to which the coordinate point belongs may be determined. An average distance of the distances between the coordinate points and the corresponding reference driving trail may be designated as a deviation between the coordinate points and the corresponding reference driving trail corresponding to the each of the segments.

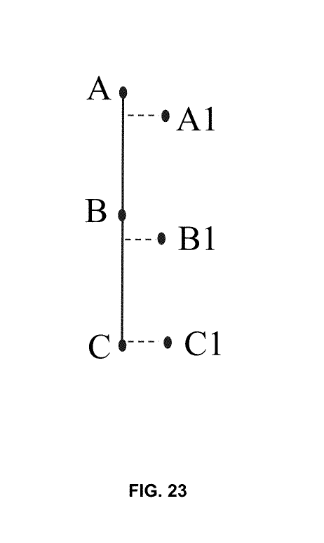

Referring to FIG. 23, still taking the recommended driving path shown in FIG. 22 as an example, the Line AC may be a reference driving trail corresponding to the segment. Point A1, Point B1, and Point C1 may correspond to coordinate points uploaded by the driver terminal, respectively. In some embodiments, distances of Point A1, Point B1, and Point C1 to the line on which the Line AC lies may be determined. It may be assumed that the corresponding value is L1, L2, and L3, and then an average distance of the L1, L2, and L3 may be designated as a deviation between the coordinate points belonging to the segment and the reference driving trail corresponding to the segment.

FIG. 23 is merely illustrative, and the reference driving trail corresponding to each segment may be a curve in practical applications.

In 2010, an average deviation of the each of the plurality of segments may be determined based on the deviation of the each of the one or more segments.

In 2012, that the service order is a cheating service order may be determined based on a determination result that the average deviation is less than a deviation threshold.

If the processing engine 112 determines that the recommended driving path includes four segments, for each segment, the processing engine 112 may determine an average value of deviations, i.e., an average deviation, between coordinate points belonging to the each segment and the reference driving trail corresponding to the each segment.

In some embodiments, a cheating service order may be recognized based on a relationship between the average deviation and the deviation threshold. In general, if the processing engine 112 determines that the average deviation is equal to or larger than the deviation threshold, the processing engine 112 may consider that there is a large difference in shapes of the driving path uploaded by the driver terminal and the recommended driving path the during a process for completing the service order, which matches the actual driving trail of the vehicle. That the service order is not a cheating service order may be determined, accordingly. If the processing engine 112 determines that the average deviation is less than the deviation threshold, the processing engine 112 may consider that there is a small difference in shapes of the driving path uploaded by the driver terminal and the recommended driving path during a process for completing the service order, which does not match the actual driving trail of the vehicle and may be a driving trail simulated by the cheating software. That the service order is a cheating service order may be determined, accordingly.

The deviation threshold may be set by developers. The deviation threshold may be 5 meters or 10 meters.

As can be seen from the above, in the present disclosure, a cheating service order may be determined based on the deviation between the coordinate points uploaded by the driver terminal during a process for completing the service order and the reference driving trail. Therefore, a cheating service order may be recognized effectively and accurately.

Alternatively or additionally, a number count of segments in dividing the coordinate points may be determined based on the process for dividing the coordinate points uploaded by the driver terminal. If the processing engine 112 determines that the number count of segments is larger than or equal to a predetermined number, e.g., 20, 30, the processing engine 112 may determine that the driving path uploaded by the driver terminal matches the actual driving trail of the vehicle. That the service order is not a cheating service order may be determined. Thus, no deviation determination may be required, and the processing resources of the online car-hailing platform may be saved.

If the processing engine 112 determines that the number count of segments is less than the predetermined number, the processing engine 112 may perform the operations of determining a reference fitting function, and determining a deviation and recognizing a cheating service order.

The order of performing the operation 2002 and operation 2006 may be not limited in this embodiment. In another embodiment, the online car-hailing platform may perform the operation 2006 firstly, or perform the operation 2002 and operation 2006 in parallel by using a parallel thread.

Corresponding to the process for recognizing a cheating service order in the scenario of online car-hailing, the present disclosure may also provide a device for recognizing a cheating service order in the scenario of online car-hailing.

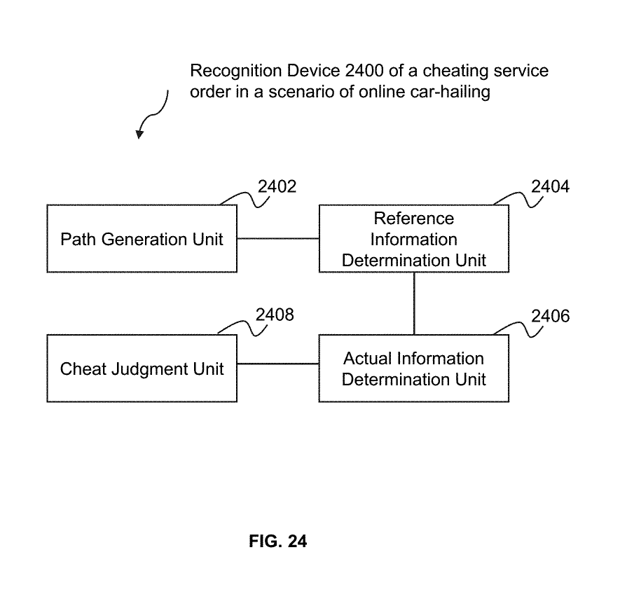

Referring to FIG. 24, a recognition device of a cheating service order in a scenario of online car-hailing may be provided. The recognition device 2400 may include a path generation unit 2402, a reference information determination unit 2404, an actual information determination unit 2406 and a cheat judgment unit 2408.

The path generation unit 2402 may be configured to obtain a start location and a destination of a service order. The path generation unit 2402 may then generate a recommended driving path based on the start location and the destination.

In some embodiments, the online car-hailing platform may obtain the start location and the destination of a service order accepted by a driver and may generate the recommended driving path based on the start location and the destination. For example, the recommended driving path may be generated by calling a map API, which may reference prior art, and will not be described in the present disclosure.

The reference information determination unit 2404 may be configured to determine reference driving information based on the recommended driving path.

In some embodiments, the reference driving information may be used to be compared with actual driving information corresponding to the service order. The reference driving information may also be used to determine whether the service order is a cheating service order. The reference driving information may include a reference time period during which an acceleration equals a first predetermined value, and a reference driving trail corresponding to one of a plurality of segments of the recommended driving path.

The actual information determination unit 2406 may be configured to determine actual driving information of the service order.

In some embodiments, the online car-hailing platform may receive various driving data uploaded by a driver terminal in the process for completing the service order, and determine the actual driving information corresponding to the service order based on the driving data. For example, an actual time period during which the acceleration equals the first predetermined value.

The cheat judgment unit 2408 may be configured to determine, based on the reference driving information and the actual driving information, whether the service order is a cheating service order.

As can be seen from the above, in the present disclosure, the reference driving information may be determined based on the recommended driving path, and then whether the service order is a cheating service order may be determined based on the comparison result of the actual driving information of the driver and the reference driving information. Therefore, a cheating service order may be recognized effectively and accurately.

In some embodiments, the reference driving information may include the reference time period during which the acceleration equals the first predetermined value.

The actual driving information may include the actual time period during which the acceleration equals the first predetermined value.

If the cheat judgment unit 2408 determines that the absolute value of the time difference between the reference time period and the actual time period during which the acceleration equals the first predetermined value is larger than the second predetermined time difference threshold, the cheat judgment unit 2408 may be configured to determine that the service order is a cheating service order.

In some embodiments, the reference information determination unit 2404 may be configured to determine a first reference time period during which the acceleration equals the first predetermined value based on a congestion condition relating to the recommended driving path.

In some embodiments, the reference information determination unit 2404 may determine a second reference time period during which the acceleration equals the first predetermined value based on intersection information relating to the recommended driving path.

The reference information determination unit 2404 may designate a sum of the first reference time period and the second reference time period as the reference time period during which the acceleration equals the first predetermined value.

In some embodiments, the actual information determination unit 2406 may determine the actual time period during which the acceleration equals the first predetermined value based on information relating to the acceleration uploaded by the driver terminal. The information relating to the acceleration may be obtained by the driver terminal from a sensor of a terminal.

In some embodiments, the first predetermined value may be 0.

As can be seen from the above, in the present disclosure, a cheating service order may be determined based on the acceleration obtained from the sensor of the driver terminal. Since the acceleration data in the sensor is not easily simulated by a cheat software, the process for determining a cheating service order provided by the present disclosure may have high accuracy. Therefore, a cheating service order can be recognized effectively and accurately.

In some embodiments, the reference driving information may include the reference driving trail corresponding to one of a plurality of segments of the recommended driving path.

The actual driving information may include coordinate points uploaded by the driver terminal during a process for completing the service order.

The cheat judgment unit 2408 may be configured to, for each of the one or more segments, determine a deviation between coordinate points belonging to the each of the plurality of segments and a reference driving trail corresponding to the each of the plurality of segments. The cheat judgment unit 2408 may determine, based on the deviations, an average deviation of the each of the plurality of segments. The cheat judgment unit 2408 may determine that the service order is a cheating service order in response to a determination that the average deviation is less than a deviation threshold.

In some embodiments, the reference information determination unit 2404 may be configured to divide the recommended driving path into one or more segments. The reference information determination unit 2404 may, for each of the one or more segments, determine a reference fitting function relating to the each of the one or more segments. The reference information determination unit 2404 may designate the reference fitting function as the reference driving trail corresponding to the each of the one or more segments.

In some embodiments, the actual information determination unit 2406 may be configured to determine distances between coordinate points belonging to the each of the plurality of segments and a reference driving trail corresponding to the each of the plurality of segments. The actual information determination unit 2406 may designate an average distance of the distances between the coordinate points belonging to the each of the plurality of segments and the reference driving trail corresponding to the each of the plurality of segments as the deviation.

In some embodiments, the cheat judgment unit 2408 may be configured to determine a number count of segments of the actual driving path based on the actual driving information. If the number count of segments is larger than or equal to a predetermined number, the cheat judgment unit 2408 may determine, based on the reference driving information and the actual driving information, that the service order is not a cheating service order.

As can be seen from the above, in the present disclosure, a cheating service order may be determined based on the deviation between the coordinate points uploaded by the driver terminal during a process for completing the service order and the reference driving trail. Therefore, a cheating service order may be recognized effectively and accurately.

For the specific implementation of functions of each unit in the above device, reference may be made to the implementation process for the corresponding operations in the above processes, and details will not be described herein.

For some embodiments of a device, reference may be made to a partial description of an embodiment of a process as it substantially corresponds to the embodiment of the process. The embodiment of the device described above is merely an example, in which the units illustrated as separate components may or may not be physically separate, the components shown as units may or may not be physical units, that is, may be located in one place or distributed to a plurality of network elements. The purpose of the present disclosure may be implemented by selecting some or all of the modules therein according to actual needs. Those skilled in the art may understand and implement the embodiments without making further creative efforts.

The system, device, module or unit set forth in the above embodiments may be specifically implemented by a computer chip or an entity, or may be implemented by a product having a certain function. A typical implementation device may be a computer. The specific form of the computer may include a personal computer, a laptop computer, a cell phone, a camera phone, a smartphone, a personal digital assistant, a media player, a navigation device, an email sending and receiving device, a game console, a tablet computer, a wearable device, or a combination thereof.

Corresponding to the process for recognizing a cheating service order in the scenario of online car-hailing, the present disclosure further provides a computer-readable storage medium in which a computer program is stored. When executed by a processor, the processing engine 112 may direct the computer program to perform following operations.

A start location and a destination of a service order may be obtained. A recommended driving path may be determined based on the start location and the destination. Reference driving information may be determined based on the recommended driving path. Actual driving information of the service order may be determined.

Whether the service order is a cheating service order may be determined based on the reference driving information and the actual driving information. In some embodiments, the reference driving information may include the reference time period during which the acceleration equals the first predetermined value.

The actual driving information may include the actual time period during which the acceleration equals the first predetermined value.

If the processing engine 112 determines that the absolute value of the time difference between the reference time period and the actual time period during which the acceleration equals the first predetermined value is larger than the second predetermined time difference threshold, the processing engine 112 may direct the computer program to determine that the service order is a cheating service order.

In some embodiments, the processing engine 112 may direct the computer program to determine a first reference time period during which the acceleration equals the first predetermined value based on a congestion condition relating to the recommended driving path.

The processing engine 112 may direct the computer program to determine a second reference time period during which the acceleration equals the first predetermined value based on intersection information relating to the recommended driving path.

The processing engine 112 may direct the computer program to designate a sum of the first reference time period and the second reference time period as the reference time period during which the acceleration equals the first predetermined value.

The processing engine 112 may direct the computer program to determine the actual time period during which the acceleration equals the first predetermined value based on information relating to the acceleration uploaded by the driver terminal. The information relating to the acceleration may be obtained by the driver terminal from a sensor of a terminal.

In some embodiments, the first predetermined value may be 0.

In some embodiments, the reference driving information may include the reference driving trail corresponding to each of a plurality of segments of the recommended driving path.

The actual driving information may include coordinate points uploaded by the driver terminal during a process for completing the service order.

The processing engine 112 may direct the computer program to, for each of the one or more segments, determine a deviation between coordinate points belonging to the each of the one or more segments and a reference driving trail corresponding to the each of the one or more segments.

The processing engine 112 may direct the computer program to determine, based on the deviation, an average deviation of the each of the plurality of segments.

The processing engine 112 may direct the computer program to determine that the service order is a cheating service order in response to a determination that the average deviation is less than a deviation threshold.

The processing engine 112 may direct the computer program to divide the recommended driving path into one or more segments.

The processing engine 112 may direct the computer program to, for each of the one or more segments, determine a reference fitting function relating to the each of the one or more segments and designate the reference fitting function as the reference driving trail corresponding to the each of the one or more segments.

The processing engine 112 may direct the computer program to determine distances between coordinate points belonging to the each of the plurality of segments and a reference driving trail corresponding to the each of the plurality of segments.

The processing engine 112 may direct the computer program to designate an average distance of the distances between the coordinate points belonging to the each of the plurality of segments and the reference driving trail corresponding to the each of the plurality of segments as the deviation.

The processing engine 112 may direct the computer program to determine whether the number count of segments is equal to or larger than a predetermined number.

If the processing engine 112 determines that the number count of segments is larger than or equal to the predetermined number, processing engine 112 may direct the computer program to determine, based on the reference driving information and the actual driving information, that the service order is not a cheating service order.

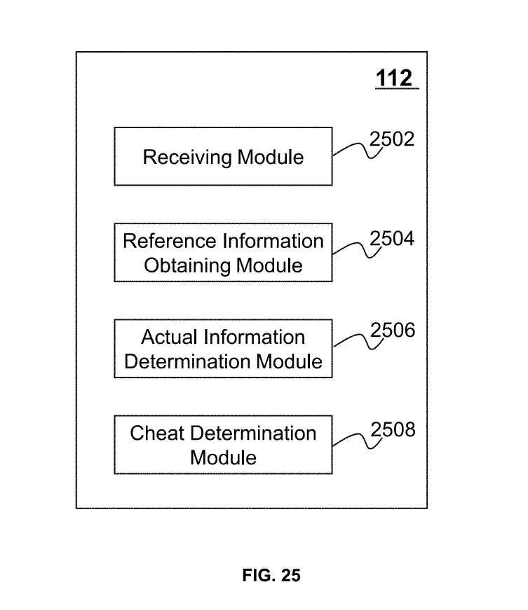

FIG. 25 is a block diagram illustrating an exemplary processing engine 112 according to some embodiments of the present disclosure. The processing engine 112 may include a receiving module 2502, a reference information obtaining module 2504, an actual information determination module 2506, and the cheat determination module 2508. At least a portion of the processing engine 112 may be implemented on a computing device as illustrated in FIG. 2 or a mobile device as illustrated in FIG. 3.

The receiving module 2502 may be configured to receive, via a network, a service order from a terminal. As used herein, the term “service order” generally refers to a service request that has been completed. The service provider may indicate that the service request has been completed at the service provider terminal 140, and the information of the completion may be transmitted to the online-to-offline service system 100. The online-to-offline service system 100 may save this service request as a service order into a storage device (e.g., the storage device 160) which may include actual driving information.

The reference information obtaining module 2504 may be configured to obtain reference information relating to the service order. The reference information obtaining module 2504 may determine a plurality of data groups relating to the service order. For each data group, the reference information obtaining module 2504 may determine reference information relating to the each data group and/or relating to the service order. For example, the reference information may include a first predetermined time difference threshold, a predetermined distance threshold, and/or a speed threshold relating to the each data group. In some embodiments, the reference information may include a second predetermined time difference threshold, a first predetermined value, a reference time period, reference driving trails, a deviation threshold, a predetermined number, and/or a deviation threshold relating to the service order. The reference information obtaining module 2504 may determine the reference information based on a plurality of non-cheating service orders.

The actual information determination module 2506 may be configured to determine actual information of the service order. In some embodiments, the processing engine 112 may determine the actual information based on the plurality of data groups determined by the reference information obtaining module 2504. For each data group, the actual information may include a time difference value, a distance value, and a speed value relating to the each data group. Alternatively or additionally, the actual information may include an actual time period and coordinate points, both of which may be associated with the actual path of the service order (e.g., the trail of the vehicle).

The cheat determination module 2508 may be configured to determine, based on the reference information and the actual information, whether the service order is a cheating service order. In some embodiments, the cheat determination module 2508 may compare the reference information and the actual information. The cheat determination module 2508 may determine, based on the result of the comparison, whether the service order is a cheating service order.

It should be noted that the above description of the processing engine 112 is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the reference information obtaining module 2504 and the actual information determination module 2506 may be integrated into one single module to perform their functions.

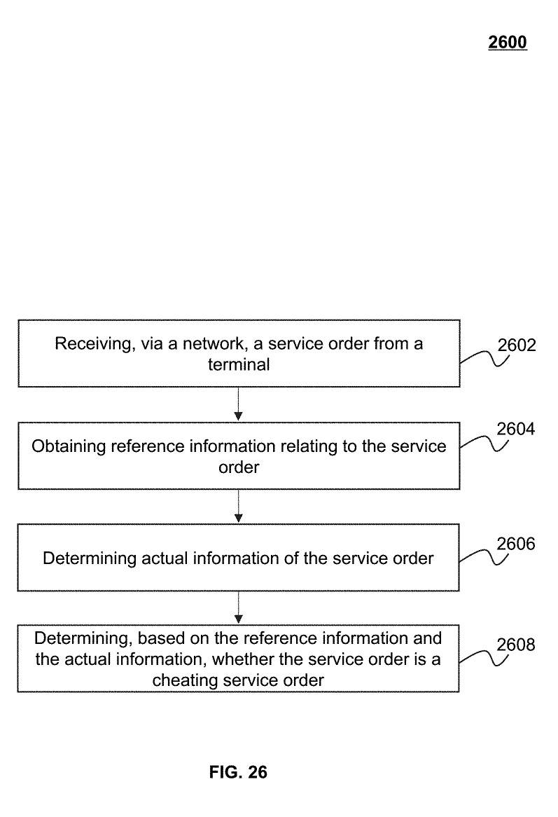

FIG. 26 is a flowchart illustrating an exemplary process for determining whether a service order is a cheating service order according to some embodiments of the present disclosure. In some embodiments, the processing engine 112 may perform the process 2600 to determine whether the service order is a cheating service order. In some embodiments, one or more operations of the process 2600 illustrated in FIG. 26 for determining whether the service order is a cheating service order may be implemented in the online-to-offline service system 100 illustrated in FIG. 1. For example, the process 2600 illustrated in FIG. 5 may be stored in the storage device 160 in the form of instructions, and invoked and/or executed by the processing engine 112 (e.g., the processor 220 of the computing device 200 as illustrated in FIG. 2, the processor 340 of the mobile device 300 as illustrated in FIG. 3).

In 2602, the processing engine 112 (e.g., the receiving module 2602) may receive, via a network, a service order from a terminal. As used herein, the term “service order” generally refers to a service request that has been completed. For example, a requestor may send a service request for a service (e.g., an online-to-offline service) to the online-to-offline service system 100 via the network 120. A service provider may accept the service request at his or her service provider terminal 140. The service provider may also provide the service to the requestor according to the service request. The service provider may further indicate that the service request has been completed at the service provider terminal 140, and the information of the completion may be transmitted to the online-to-offline service system 100. The online-to-offline service system 100 may save this service request as a service order into a storage device (e.g., the storage device 160) which may include actual driving information.

The service request may be a request for a transportation service (e.g., a taxi service). The service request may be and/or include a real-time request, an appointment request, and/or any other request for one or more types of services. As used herein, the real-time request may indicate that the requestor wishes to use a transportation service at the present moment or at a defined time reasonably close to the present moment for an ordinary person in the art. For example, a request may be a real-time request if the defined time is shorter than a threshold value, such as 1 minute, 5 minutes, 10 minutes, 20 minutes, etc. The appointment request may indicate that the requestor wishes to schedule a transportation service in advance (e.g., at a defined time which is reasonably far from the present moment for the ordinary person in the art). For example, a request may be an appointment request if the defined time is longer than a threshold value, such as 20 minutes, 2 hours, 1 day, etc. In some embodiments, the processing engine 112 may define the real-time request or the appointment request based on a time threshold. The time threshold may be default settings of the online-to-offline service system 100 or may be adjustable in different situations. For example, in a traffic peak period, the time threshold may be relatively small (e.g., 10 minutes). In an idle period (e.g., 10:00-12:00 am), the time threshold may be relatively large (e.g., 1 hour).

In 2604, the processing engine 112 (e.g., the reference information obtaining module 2504) may obtain reference information relating to the service order. In some embodiments, the processing engine 112 may determine a plurality of checkpoints relating to the service order. Each checkpoint may include an event name, a time point, and a position coordinate. Exemplary event names may include passenger's initiating a service request, driver's acceptance of the service request, picking up of the passenger by the driver, start of the travelling, end of the travelling, passenger payment, passenger evaluation, passenger's initiating a subsequent service request, driver's acceptance of a subsequent service request next time, or the like. The processing engine 112 may arrange the plurality of checkpoints in chronological order. The processing engine 112 may designate two adjacent checkpoints in the chronological order as a data group.

For each data group, the processing engine 112 may determine reference information relating to the each data group and/or relating to the service order. For example, the reference information may include a first predetermined time difference threshold, a predetermined distance threshold, and/or a speed threshold relating to the each data group. Alternatively or additionally, the reference information may include a predetermined probability. In some embodiments, the predetermined probability may be dynamically adjusted and/or a fixed value (e.g., 80%, 85%, 90%).

In some embodiments, the processing engine 112 may determine the first predetermined time difference threshold, the predetermined distance threshold, and/or the speed threshold based on actual information relating to a plurality of non-cheating service orders. For example, the processing engine 112 may obtain time differences relating to the plurality of non-cheating service orders. The processing engine 112 may statistically determine the distribution of time differences relating to the each data group in space and/or in time. The processing engine 112 may determine, based on the statistically determined distribution of time differences, the first predetermined time difference threshold relating to the each data group. Time difference used herein refers to the difference between time points of the two checkpoints of the each data group.

Alternatively or additionally, the processing engine 112 may obtain distance differences relating to the plurality of non-cheating service orders. The processing engine 112 may statistically determine the distribution of distance differences relating to the each data group in space and/or in time. The processing engine 112 may determine, based on the statistically determined distribution of distance differences, the predetermined distance difference threshold relating to the each data group. Distance difference used herein refers to the straight distance between two positions relating the two checkpoints (e.g., two geographic coordinate sets relating to the two checkpoints, respectively) of the each data group.

Alternatively or additionally, the processing engine 112 may determine the actual road condition relating to the service order on the day of the serviced order. The road condition may relate to a path relating to the service order. The processing engine 112 may determine the speed threshold based on the actual road condition. In some embodiments, the processing engine 112 may statistically determine the speed threshold based on distribution of speed value in space and/or in time. More descriptions of determining the speed threshold can be found elsewhere in the present disclosure (e.g., FIG. 7 and FIG. 14, and the descriptions thereof).

In some embodiments, the reference information may include a second predetermined time difference threshold, a first predetermined value, a reference time period, reference driving trails, a deviation threshold, a predetermined number, and/or a deviation threshold relating to the service order. The processing engine 112 may also statistically determine the deviation threshold and/or the predetermined number based on the plurality of non-cheating service orders. Descriptions of determining the second predetermined time difference threshold can be found elsewhere in the present disclosure (e.g., FIG. 19, and the descriptions thereof).

In some embodiments, the reference time period may be a period during which the acceleration (or the speed) of a vehicle equal to a first predetermined value (e.g., 0 m/s² or 0 m/s). The reference time period may include a first reference time period and a second reference time period. The acceleration may equal to the predetermined value during both the first reference time period and the second reference time period. In some embodiments, the first predetermined value may relate to a value of acceleration and be set by an operator of the processing engine 112. The predetermined value may be in a range of 0 to 0.1 m/s².

The processing engine 112 may determine the first reference time period based on a congestion condition relating to a recommended driving path. The processing engine 112 may determine the recommended driving path based on the start location and the destination of the service order. The processing engine 112 may also determine the second reference time period based on intersection information relating to the recommended driving path. More descriptions of the reference time period can be found elsewhere in the present disclosure (e.g., FIG. 19 and FIG. 24, and the descriptions thereof).

In some embodiments, the processing engine 112 may divide the recommended path into a plurality of segments. More descriptions of dividing the recommended path into the plurality of segments can be found elsewhere in the present disclosure (e.g., FIGS. 20-24, and the descriptions thereof). For each segment, the processing engine 112 may determine a reference fitting function. The processing engine 112 may designate a trail relating to the reference fitting function as the reference driving trail.

In 2606, the processing engine 112 (e.g., the actual information determination module 2606) may determine actual information of the service order. In some embodiments, the actual information may include checkpoint information relating to the service order. The processing engine 112 may collect the checkpoint information relating to the plurality of checkpoints of the service order. Checkpoint information relating to each checkpoint may include an event name, a time point, a position coordinate, or the like, or a combination thereof. As described in connection with operation 2604, the processing engine 112 may determine a plurality of data groups based on the checkpoint information relating to the plurality of checkpoints.

The processing engine 112 may determine the actual information based on the plurality of data groups. In some embodiments, for each data group, the actual information may include a time difference value, a distance value, and a speed value relating to the each data group. The processing engine 112 may determine the difference between two time points relating to the each data group and designate the determined difference as the time difference value of the each data group. For example, for the data group associated with two adjacent checkpoints (e.g., start of the travelling and end of the travelling), the processing engine 112 may, based on checkpoint information of the two adjacent checkpoints, determine the time difference value, the distance value, and the speed value.

Alternatively or additionally, the processing engine 112 may determine the straight distance between two positions relating the two checkpoints (e.g., two geographic coordinate sets relating to the two checkpoints, respectively) and designate the determined straight distance as the distance value of the each data group. The processing engine 112 may determine a quotient based on the time difference value and the distance value of the each data group and designate the determined quotient as the speed value of the each data group.

Alternatively or additionally, the actual information may include an actual time period and coordinate points, both of which may be associated with the actual path of the service order (e.g., the trail of the vehicle). The actual time period used herein referes to a time period during the acceleration of the vehicle (which may be determined by determining the acceleration of the service provider terminal and/or service requester terminal) associated with the service order equals the first predetermined value. In some embodiments, the first predetermined value may relate to a value of acceleration and be set by an operator of the processing engine 112. The first predetermined value may be in a range of 0 to 0.1 m/s². The coordinate points may belong to the plurality of segments and uploaded by the service provider terminal and/or the service requester terminal during the process for completing the service order. The processing engine 112 may determine the actual time period and the coordinate points belonging to the plurality of segments. More descriptions of determining the actual time period and the coordinate points can be found elsewhere in the present disclosure (e.g., FIGS. 19-20 and FIG. 24 and the descriptions thereof).

In 2608, the processing engine 112 may determine, based on the reference information and the actual information, whether the service order is a cheating service order. In some embodiments, the processing engine 112 may compare the reference information and the actual information. The processing engine 112 may determine, based on the result of the comparison, whether the service order is a cheating service order.

In some embodiments, for each data group, the processing engine 112 may determine whether the time difference value relating to the each data group is larger than the first predetermined time difference threshold. The processing engine 112 may determine, based on a result of the determination that the time difference value of the each data groups is larger than the first predetermined time difference threshold, whether the speed value of the each of the plurality of data group is less than or equal to the speed threshold. The processing engine 112 may determine, based on a result of the determination that the speed value of the each data group is less than or equal to the speed threshold, that the each data groups has reachability. On the other hand, the processing engine 112 may determine, based on a result of the determination that the speed value of the each data group is larger than the speed threshold, that the each of the plurality of data groups has not reachability.

In some embodiments, the processing engine 112 may determine, based on a result of the determination that the time difference value of the each of the plurality of data groups is less than or equal to the first predetermined time difference threshold, whether the distance value of the each of the plurality of data groups is less than or equal to the predetermined distance threshold. The processing engine 112 may determine, based on a result of the determination that the distance value of the each of the plurality of data groups is less than or equal to the predetermined distance threshold, that the each of the plurality of data groups has reachability. On the other hand, the processing engine 112 may determine, based on a result of the determination that the distance value of the each of the plurality of data groups is greater than the predetermined distance threshold, that the each of the plurality of data groups has not reachability.

In some embodiments, the processing engine 112 may determine the reachability relating to all the data groups. The processing engine 112 may determine the proportion of the data groups that have reachability as the ratio of reachability of the service order. More descriptions of determining the proportion of the plurality of data groups that have reachability be found elsewhere in the present disclosure (e.g., FIG. 8, FIG. 10A, FIG. 10B, and FIG. 15 and the descriptions thereof). The processing engine 112 may determine whether the ratio of reachability is less than or equal to the predetermined probability. The processing engine 112 may determine, based on a result of the determination that the ratio of reachability is less than or equal to the predetermined probability, that the service order is a cheating service order. On the other hand, the processing engine 112 may determine, based on a result of the determination that the ratio of reachability is less than or equal to the predetermined probability, that the service order is not a cheating service order. More descriptions of determining, based on information relating to the data groups, whether the service order is a cheating service order can be found elsewhere in the present disclosure (e.g., FIGS. 4-17, and the descriptions thereof).

In some embodiments, the processing engine 112 may determine reachability relating to all the data groups and then determine whether the service order is a cheating service order. More descriptions of determining the reachability relating to all the plurality of data groups and then determining whether the service order is a cheating service order can be found elsewhere in the present disclosure (e.g., FIG. 9 and FIG. 16, and the descriptions thereof).

If the processing engine 112 determines, based on the information relating to the data groups, whether the service order is a cheating service order, the processing engine 112 may statistically analyze the data relating to a plurality of non-cheating service orders. The processing engine 112 may determine one or more features at different time points and in different regions. Exemplary feature may include a statistical speed value (e.g., the speed threshold). Each data group may represent a driver and/or a passenger traveling from a location to another location, which results in an actual speed value. If the difference between the statistical speed value and the actual speed value is larger than a threshold, the processing engine 112 may determine that this data group has no reachability. Similarly, the processing engine 112 may determine whether the service order is a cheating service order based on the reachabilities of the data groups.

In some embodiments, the processing engine 112 may determine an absolute value of the time difference between the reference time period and the actual time period. The processing engine 112 may determine whether the absolute value of the time difference is larger than the second predetermined time difference threshold. The processing engine 112 may determine that the service order is a cheating service order based on a determination result that the absolute value of the time difference is larger than the second predetermined time difference threshold.

In some embodiments, for each segment of the actual route of the vehicle, the processing engine 112 may determine the distances between position coordinates belonging to the each segment and the reference driving trail corresponding to the each segment. For each position coordinate belonging to the each segment, the processing engine 112 may determine a distance between the each position coordinate belonging to the each segment and the reference driving trail corresponding to the each segment. The processing engine 112 may determine, based on the distances relating to the position coordinates belonging to the each segment, an average value of distances. The processing engine 112 may designate the average value of distance as the deviation between the position coordinates belonging to the each segment and the reference driving trail corresponding to the each segment. The processing engine 112 may determine, based on the deviations relating to the plurality of segments, an average deviation of the plurality of segments.

The processing engine 112 may also determine whether the average deviation is less than a deviation threshold. The processing engine 112 may determine that the service order is a cheating service order based on a result of the determination that the average deviation is less than the deviation threshold. On the other hand, the processing engine 112 may determine that the service order is not a cheating service order based on a result of the determination that the average deviation is larger than or equal to the deviation threshold. More descriptions of determining, based on information relating to acceleration and driving trails, whether the service order is a cheating service order can be found elsewhere in the present disclosure (e.g., FIGS. 18-24, and the descriptions thereof).

The processing engine 112 may statistically analyze the data relating to a plurality of non-cheating service orders. The processing engine 112 may determine one or more features at different time points and in different regions. For example, the processing engine 112 may determine a statistical time period (e.g., reference time period) and statistical driving trails (reference driving trails). The processing engine 112 may also compare the actual time period with the statistical time period. The processing engine 112 may also compare actual position coordinates of driving paths with the statistical driving trails. If each of the two comparison results is larger than a threshold, the processing engine 112 may determine that the service order is a cheating service order.

It should be noted that the above descriptions about the processing of traversing the plurality of data groups are provided for illustration purposes, and should not be designated as the only practical embodiment. For persons having ordinary skills in the art, after understanding the general principle of the process for traversing the plurality of data groups, without departing the principle, may modify or change the forms or details of the particular practical ways and operations, and further make simple deductions or substitutions, or may make modifications or combinations of some operations without further creative efforts. However, those variations and modifications do not depart the scope of the present disclosure. Additionally or alternatively, one or more operations may be omitted. In some embodiments, two or more operations may be integrated into a operation, or a operation may be separated into two operations.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer-readable medium having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1-9. (canceled)

10. A system for examining a cheating service order, the system comprising:
an acquisition module configured to collect, via a network, checkpoint information relating to each checkpoint of a plurality of checkpoints, the plurality of checkpoints being associated with a service order;
a calculation module configured to generate a plurality of data groups based on the checkpoint information;
for each data group of the plurality of data groups:
a first judgment module configured to determine whether data relating to the each data group of the plurality of data groups is within a predetermined range and determine whether the each data group has reachability based on a result of the determination whether the data relating to the each data group of the plurality of data groups is within the predetermined range; and
a second judgment module configured to determine whether the service order is a cheating service order based on a result of the determination of the reachability of the plurality of data groups.

11. (canceled)

12. The system of claim 10, wherein the calculation module comprises:
a grouping unit configured to arrange the plurality of checkpoints in chronological order and designate two adjacent checkpoints in the chronological order as a data group; and
for each data group of the plurality of data groups,
a first calculation unit configured to determine a straight distance value between two position coordinates relating to the each data group and designate the determined straight distance value as the distance value of the each data group;
a second calculation unit configured to determine a difference between two time points relating to the each data group and designate the determined difference as the time difference value of the each data group;
a third calculation unit configured to determine a quotient based on the time difference value and the distance value of the each data group; and
designate the determined quotient as a speed value of the each data group.

13. The system of claim 10, wherein the first judgment module comprises:
for each data group of the plurality of data groups,
a first judgment unit configured to determine whether the time difference value of the each data group is larger than a predetermined time difference threshold;
if the time difference value of the each data group is larger than the predetermined time difference threshold,
an assessment unit configured to determine for a statistical maximum speed value corresponding to the each data group and determine a speed threshold relating to the each data group, the statistical maximum speed value determined based on an actual road condition of a day of the service order;
a second judgment unit configured to determine whether the speed value of the each data group is less than or equal to the speed threshold;
if the speed value of the each data group is less than or equal to the speed threshold,
the second judgment unit further configured to determine that the each data group has reachability;
if the time difference value of the each data group is less than or equal to the predetermined time difference threshold,
a third judgment unit configured to determine whether the distance value of the each data group is less than or equal to a predetermined distance threshold; and
if the distance value of the each data group is less than or equal to the predetermined distance threshold,
the third judgment unit further configured to determine that the each data group has reachability.

14. (canceled)

15. The system of claim 10, wherein the second judgment module comprises:
a fourth calculation unit configured to determine a proportion of the plurality of data groups that have reachability as a ratio of reachability of the service order; and
a fourth judgment unit configured to determine whether the ratio of reachability is less than or equal to a predetermined probability,
if the ratio of reachability is less than or equal to the predetermined probability,
the fourth judgment unit further configured to determine that the service order is a cheating service order.

16. The system of claim 10, wherein the acquisition module executes a step of collecting the checkpoint information from a passenger terminal and a driver terminal.

17-30. (canceled)

31. A recognition device of a cheating service order in a scenario of online car-hailing, the device comprising:
a path generation unit configured to generate a recommended driving path based on a start location and a destination of a service order;
a reference information determination unit configured to determine reference driving information based on the recommended driving path;
an actual information determination unit configured to determine actual driving information of the service order; and
a cheat judgment unit configured to determine, based on the reference driving information and the actual driving information, whether the service order is a cheating service order.

32. The device of claim 31, wherein
the reference driving information includes a reference time period during which an acceleration equals a first predetermined value,
the actual driving information includes an actual time period during which an acceleration equals the first predetermined value, and
the cheat judgment unit is further configured to determine that an absolute value of a time difference between the reference time period and the actual time period is larger than a predetermined time difference threshold and determine that the service order is a cheating service order based on a result of the determination that the absolute value of the time difference is larger than the predetermined time difference threshold.

33-35. (canceled)

36. The device of claim 31, wherein
the reference driving information includes reference driving trails, each of the reference driving trails corresponding to one of one or more segments of the recommended driving path,
the actual driving information includes coordinate points uploaded by a driver terminal during a process for completing the service order, and
the cheat judgment unit is further configured to:
for each of one or more segments of the recommended driving path, determine a deviation between coordinate points belonging to the each of the one or more segments and a reference driving trail corresponding to the each of the one or more segments;
determine, based on the deviations, an average deviation of the one or more segments;
determine whether the average deviation is less than a deviation threshold; and
determine that the service order is a cheating service order based on a determination result that the average deviation is less than the deviation threshold.

37-38. (canceled)

39. The device of claim 36, wherein the cheat judgment unit is further configured to:
determine, based on the actual driving information, a number count of segments of an actual driving path;
determine whether the number count is equal to or larger than a predetermined number; and
execute, based on the reference driving information and the actual driving information, a step of determining whether the service order is a cheating service order based on a determination result that number is equal to or larger than the predetermined number.

40-41. (canceled)

42. A system comprising:
a storage device storing a set of instructions; and
one or more processors in communication with the storage device, wherein when executing the set of instructions, the one or more processors are configured to cause the system to:
receive, via a network, a service order from a terminal;
obtain reference information relating to the service order;
determine actual information of the service order; and
determine, based on the reference information and the actual information, whether the service order is a cheating service order.

43. The system of claim 42, wherein the reference information includes a first predetermined time difference threshold, a predetermined distance threshold, a speed threshold, and a predetermined probability.

44. The system of claim 43, wherein to determine the actual information of the service order, the one or more processors are configured to cause the system to:
receive, via the network, checkpoint information relating to a plurality of checkpoints, the plurality of checkpoints being associated with the service order, each of the plurality of checkpoints being associated with a time point and a position;
arrange, based on the time points associated with the plurality of checkpoints, the plurality of checkpoints in chronological order;
determine a plurality of data groups relating to the service order based on the plurality of checkpoints, each of the plurality of data groups including two adjacent checkpoints in the chronological order; and
for each of the plurality of data groups, determine, based on time points and positions coordinates relating to the each of plurality of data groups, a time difference value, a distance value, and a speed value.

45. The system of claim 44, wherein to determine, based on the reference information and the actual information, whether the service order is a cheating service order, the one or more processors are configured to cause the system to:
for each of the plurality of data groups:
determine whether the time difference value of the each of the plurality of data groups is larger than the first predetermined time difference threshold;
determine, based on a result of the determination that the time difference value of the each of the plurality of data groups is larger than the first predetermined time difference threshold, whether the speed value of the each of the plurality of data groups is less than or equal to the speed threshold; and
determine, based on a result of the determination that the speed value of the each of the plurality of data groups is less than or equal to the speed threshold, that the each of the plurality of data groups has reachability.

46. The system of claim 45, wherein to determine, based on the reference information and the actual information, whether the service order is a cheating service order, the one or more processors are further configured to cause the system to:
for the each of the plurality of data groups:
determine whether the time difference value of the each of the plurality of data groups is less than or equal to the first predetermined time difference threshold;
determine, based on a result of the determination that the time difference value of the each of the plurality of data groups is less than or equal to the first predetermined time difference threshold, whether the distance value of the each of the plurality of data groups is less than or equal to the predetermined distance threshold; and
determine, based on a result of the determination that the distance value of the each of the plurality of data groups is less than or equal to the predetermined distance threshold, that the each of the plurality of data groups has reachability.

47. The system of claim 46, wherein to determine, based on the reference information and the actual information, whether the service order is a cheating service order, the one or more processors are configured to cause the system to:
determine a proportion of the plurality of data groups that have reachability as a ratio of reachability of the service order;
determine whether the ratio of reachability is less than or equal to the predetermined probability; and
determine, based on a result of the determination that the ratio of reachability is less than or equal to the predetermined probability, that the service order is a cheating service order.

48. The system of claim 42, wherein:
the reference information includes a recommended driving path and a reference time period, and
to obtain reference information relating to the service order, the one or more processors are configured to cause the system to:
generate the recommended driving path based on a start location and a destination of the service order;
estimate, based on a congestion condition relating to the recommended driving path, a first reference time period during which an acceleration equals a first predetermined value;
estimate, based on intersection information relating to the recommended driving path, a second reference time period during which the acceleration equals the first predetermined value;
determine a sum of the first reference time period and the second reference time period; and
designate the sum as the reference time period.

49. The system of claim 48, wherein:
the actual information includes an actual time period during which an acceleration of a vehicle associated with the service order equals to the first predetermined value, and
to determine, based on the reference information and the actual information, whether the service order is a cheating service order, the one or more processors are configured to cause the system to:
determine whether an absolute value of a time difference between the reference time period and the actual time period is larger than a second predetermined time difference threshold; and
determine, based on a result of the determination that the absolute value of the time difference is larger than the second predetermined time difference threshold, that the service order is a cheating service order.

50. The system of claim 42, wherein the reference information includes a recommended driving path, reference driving trails, and a deviation threshold, and
to obtain reference information relating to the service order, the one or more processors are configured to cause the system to:
generate the recommended driving path based on a start location and a destination of the service order;
divide the recommended driving path into a plurality of segments;
for each of the plurality of segments, determine a reference fitting function relating to the each of the plurality of segments; and
designate the reference fitting function as the reference driving trail corresponding to the each of the plurality of segments.

51. The system of claim 50, wherein the actual information of the service order includes coordinate points belonging to the each of the plurality of segments and uploaded by a driver terminal in a process for completing the service order, and
to determine, based on the reference information and the actual information, whether the service order is a cheating service order, the one or more processors are configured to cause the system to:
for each of the plurality of segments of the recommended driving path, determine a deviation between the coordinate points belonging to the each of the plurality of segments and a reference driving trail corresponding to the each of the plurality of segments;
determine, based on the deviations of the plurality of segments, an average deviation relating to the plurality of segments;
determine whether the average deviation is less than the deviation threshold; and
determine, based on a result of the determination that the average deviation is less than the deviation threshold, that the service order is a cheating service order.

52. The system of claim 42, wherein the reference information includes a predetermined number, and
to determine, based on the reference information and the actual information, whether the service order is a cheating service order, the one or more processors are configured to cause the system to:
determine, based on the actual information, a number count of segments of an actual driving path relating to the service order;
determine whether the number count is equal to or larger than the predetermined number; and
determine, based on a result of the determination that the number count is equal to or larger than the predetermined number, that the service order is not a cheating service order.

53-64. (canceled)
